(19) United States
(12) Patent Application Publication
(10) Pub. No.: US 2025/0176052 A1
(43) Pub. Date: May 29, 2025

(54) METHOD, DEVICE AND COMPUTER STORAGE MEDIUM OF COMMUNICATION

(71) Applicant: NEC CORPORATION, Tokyo (JP)

(72) Inventors: Gang WANG, Beijing (CN); Yukai GAO, Beijing (CN); Peng GUAN, Beijing (CN)

(73) Assignee: NEC CORPORATION, Tokyo (JP)

(21) Appl. No.: 18/841,782

(22) PCT Filed: Feb. 28, 2022
(86) PCT No.: PCT/CN2022/078484

§ 371 Date: Aug. 27, 2024

(51) Int. Cl. H04W 76/19; H04B 7/06; H04W 76/20

(52) U.S. Cl. CPC H04W 76/19; H04B 7/06952; H04W 76/20

(57) ABSTRACT

Embodiments of the present disclosure relate to methods, devices and computer readable media of communication. A terminal device receives, from a network device, a first indication indicating a set of TCI states for a CORESET and determines whether a BFR procedure is to be performed in application time associated with at least one TCI state in the set of TCI states. If no BFR procedure is to be performed, the terminal device stops the BFR procedure in the application time associated with the at least one TCI state. If the BFR procedure is to be performed, the terminal device performs the BFR procedure in the application time associated with the at least one TCI state. In this way, management of a BFR procedure based on beam prediction may be achieved.

### TECHNICAL FIELD

Embodiments of the present disclosure generally relate to the field of telecommunication, and in particular, to methods, devices and computer storage media of communication for beam failure recovery (BFR).

### BACKGROUND

Recently, beam prediction in time domain based on artificial intelligence (AI) or machine learning (ML) technology is introduced. In case of beam prediction in time domain, a network device may indicate a set of transmission configuration indicator (TCI) states to be applied to a channel or reference signal for a long time in the future. A terminal device may switch beams autonomously according to orders and application time associated with TCI states in the indicated set of TCI states.

With the beam prediction, occurrence of BFR may be avoided as much as possible. However, the beam prediction may have a certain impact on an existing BFR procedure, e.g., whether or when BFR is needed. Further, the most accurate prediction method may still not avoid occurrence of unexpected events such as obstacles, a rotation of the terminal device, etc., Thus, how to manage a BFR procedure based on beam prediction needs to be defined.

### SUMMARY

In general, embodiments of the present disclosure provide methods, devices and computer storage media of communication for management of a BFR procedure based on beam prediction.

In a first aspect, there is provided a method of communication. The method comprises: receiving, at a terminal device and from a network device, a first indication indicating a set of TCI states for a control resource set (CORESET); determining whether a BFR procedure is to be performed in application time associated with at least one TCI state in the set of TCI states; in accordance with a determination that no BFR procedure is to be performed, stopping the BFR procedure in the application time associated with the at least one TCI state; and in accordance with a determination that the BFR procedure is to be performed, performing the BFR procedure in the application time associated with the at least one TCI state.

In a second aspect, there is provided a method of communication. The method comprises: transmitting, at a network device and to a terminal device, a first indication indicating a set of TCI states for a CORESET; determining whether a BFR procedure is to be performed in application time associated with at least one TCI state in the set of TCI states; in accordance with a determination that no BFR procedure is to be performed, stopping the BFR procedure in the application time associated with the at least one TCI state; and in accordance with a determination that the BFR procedure is to be performed, performing the BFR procedure in the application time associated with the at least one TCI state . . . .

In a third aspect, there is provided a terminal device. The terminal device comprises a processor configured to perform the method according to the first aspect of the present disclosure.

In a fourth aspect, there is provided a network device. The network device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication according to some embodiments of the present disclosure;

FIG. 3A illustrates a schematic diagram illustrating an example configuration of a set of TCI states according to some embodiments of the present disclosure;

FIG. 3B illustrates a schematic diagram illustrating an example management of a BFR procedure according to some embodiments of the present disclosure;

FIG. 3C illustrates a schematic diagram illustrating an example management of a BFR procedure according to some embodiments of the present disclosure;

FIG. 3D illustrates a schematic diagram illustrating an example management of a BFR procedure according to some embodiments of the present disclosure;

FIG. 3E illustrates a schematic diagram illustrating an example management of a BFR procedure according to some embodiments of the present disclosure;

FIG. 3F illustrates a schematic diagram illustrating an example management of a BFR procedure according to some embodiments of the present disclosure;

FIG. 3G illustrates a schematic diagram illustrating an example management of a BFR procedure according to some embodiments of the present disclosure;

FIG. 4A illustrates a schematic diagram illustrating an example management of a BFR procedure according to some embodiments of the present disclosure;

FIG. 4B illustrates a schematic diagram illustrating an example management of a BFR procedure according to some embodiments of the present disclosure;

FIG. 4C illustrates a schematic diagram illustrating an example management of a BFR procedure according to some embodiments of the present disclosure;

FIG. 4D illustrates a schematic diagram illustrating an example management of a BFR procedure according to some embodiments of the present disclosure;

FIG. 4E illustrates a schematic diagram illustrating an example management of a BFR procedure according to some embodiments of the present disclosure;

FIG. 4F illustrates a schematic diagram illustrating an example management of a BFR procedure according to some embodiments of the present disclosure;

FIG. 4G illustrates a schematic diagram illustrating an example management of a BFR procedure according to some embodiments of the present disclosure;

FIG. 4H illustrates a schematic diagram illustrating an example management of a BFR procedure according to some embodiments of the present disclosure;

FIG. 5A illustrates a schematic diagram illustrating an example management of a BFR procedure according to some embodiments of the present disclosure;

FIG. 5B illustrates a schematic diagram illustrating an example management of a BFR procedure according to some embodiments of the present disclosure;

FIG. 6A illustrates a schematic diagram illustrating an example problem of a BFD procedure according to some embodiments of the present disclosure;

FIG. 6B illustrates a schematic diagram illustrating an example management of a BFD procedure according to some embodiments of the present disclosure;

FIG. 6C illustrates a schematic diagram illustrating an example management of a BFD procedure according to some embodiments of the present disclosure;

FIG. 6D illustrates a schematic diagram illustrating an example management of a BFD procedure according to some embodiments of the present disclosure;

FIG. 7 illustrates an example method of communication implemented at a terminal device in accordance with some embodiments of the present disclosure;

FIG. 8 illustrates an example method of communication implemented at a network device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “PSCell” refers to a SpCell of a secondary cell group (SCG), the term “PCell” refers to a SpCell of a master cell group (MCG), and the term “SpCell” refers to a primary cell of a SCG or MCG. The term “SCell” refers to a secondary cell of a SCG or MCG.

As mentioned above, how to manage a BFR procedure based on beam prediction needs to be defined. For example, whether a BFR procedure is needed, when a BFR procedure is needed, how a BFR procedure runs based on a set of TCI states, etc.,

Embodiments of the present disclosure provide a solution for solving the above and other potential issues. In the solution, a terminal device receives an indication indicating a set of TCI states for a CORESET, and determines whether a BFR procedure is to be performed in application time associated with at least one TCI state in the set of TCI states. If no BFR procedure is to be performed, the terminal device stops the BFR procedure in the application time associated with at least one TCI state. If the BFR procedure is to be performed, the terminal device performs the BFR procedure in the application time associated with at least one TCI state. In this way, a BFR procedure based on a set of TCI states may be clearly defined.

In the context of the present application, the term “stop” can be used interchangeably with the term “terminate” or “suspend”. Further, the term “application time associated with a TCI state” means application time corresponding to the TCI state.

Principles and implementations of the present disclosure will be described in detail below with reference to the figures.

### Example of Communication Network

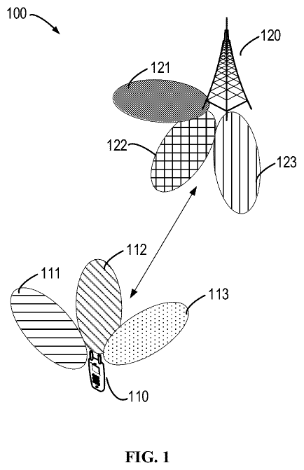

FIG. 1 illustrates an example communication network 100 in which embodiments of the present disclosure can be implemented. As shown in FIG. 1, the communication network 100 includes a terminal device 110 and a network device 120 served by the terminal device 110.

As shown in FIG. 1, the terminal device 110 may have a plurality of beams such as beams 111, 112 and 113, and the network device 120 may have a plurality of beams such as beams 121, 122 and 123. A channel (or called as a sub-channel in this case) may be formed between one of beams 111, 112 and 113 and one of beams 121, 122 and 123. The terminal device 110 may transmit information to the network device 120 or receive information from the network device 120 via one or more of the beams 111, 112 and 113. The network device 120 may transmit information to the terminal device 110 or receive information from the terminal device 110 via one or more of the beams 121, 122 and 123.

It is to be understood that the number of devices and beams in FIG. 1 is given for the purpose of illustration without suggesting any limitations to the present disclosure. The communication network 100 may include any suitable number of network devices and/or terminal devices and/or beams adapted for implementing implementations of the present disclosure.

The terminal device 110 may communicate with the network device 120 via a channel such as a wireless communication channel. The communications in the communication network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

Communication in a direction from the terminal device 110 towards the network device 120 is referred to as UL communication, while communication in a reverse direction from the network device 120 towards the terminal device 110 is referred to as DL communication. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

In some scenarios, the terminal device 110 may detect quality (for example, a block error rate (BLER) or the like) of a current beam (for example, the beam 111) of PDCCH, and compare the quality with first threshold quality. For example, the current beam may correspond to a reference signal (RS) in a set (denoted as q0) of RSs for beam failure detection (BFD). If the quality of the current beam is worse than the first threshold quality, the terminal device 110 may inform this event from a lower layer to a higher layer of the terminal device 110. For example, the terminal device 110 may transmit a beam failure indicator (BFI) from the lower layer to the higher layer. At this time, a counter (denoted as BFI_COUNTER here) configured for BFI may be increased by 1. If such event occurs N times continuously, for example, N=2, a beam failure may be declared. This procedure is called as BFD.

Upon declaration of a beam failure, the terminal device 110 may select a new beam (denoted as q_new) from a configured set (denoted as q1) of candidate beams, and the quality (for example, layer 1-reference signal receiving power (L1-RSRP) or the like) of the new beam needs to be better than or equal to second threshold quality. Upon request from the higher layer, the lower layer of the terminal device 110 may provide the new beam to the higher layer. This procedure is called as a new beam indication (NBI).

The terminal device 110 may report the selected new beam to the network device 120. This procedure is called as a BFR request (BFRQ).

The terminal device 110 may start to monitor PDCCHs in CORESETs (denoted as CORESET-BFR here) dedicated to BFR after a period of time after the report of the new beam. The network device 120 may use the new beam to transmit the PDCCHs in CORESET-BFR. The terminal device 110 may receive the first PDCCH in the PDCCHs as a BFR response (BFRR). After a predetermined number of symbols (for example, 28 symbols) upon reception of the BFRR, the terminal device 110 may apply the new beam to all PDCCHs in all CORESETs, scheduled PDSCHs and PUCCHs. This procedure is called as a BFRR.

In some scenarios, the network device 120 may perform beam prediction based on AI or ML technology to obtain a set of TCI states, and indicate the set of TCI states to the terminal device 110. The terminal device 110 may switch beams according to the order and application time associated with the set of TCI states.

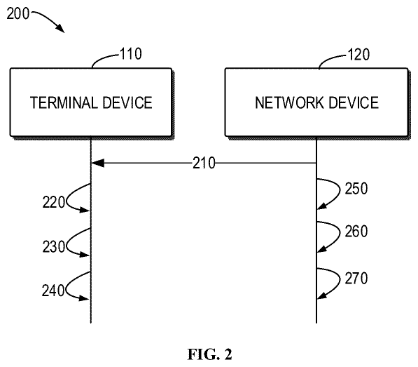

Embodiments of the present disclosure provide a solution of managing a BFR procedure based on beam prediction. The solution will be described in detail with reference to FIGS. 2 to 6C below.

### Example Implementation of BFR Procedure Based on Beam Prediction

FIG. 2 illustrates a schematic diagram illustrating a process 200 of communication according to some embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the network device 120 transmits 210, to the terminal device 110, an indication (for convenience, also referred to as a first indication herein) indicating a set of TCI states for a CORESET. In some embodiments, the CORESET may be used for determination of a RS for BFD (for convenience, also referred to as BFD-RS herein). It is to be noted that the CORESET may be in any other suitable forms, and the present disclosure does not limit this aspect.

In some embodiments, the network device 120 may carry the first indication in a medium access control (MAC) control element (CE). In some embodiments, the network device 120 may carry the first indication in a radio resource control (RRC) signaling. In some embodiments, the network device 120 may carry the first indication in downlink control information (DCI). It is to be understood that the first indication may be transmitted in any other suitable ways, and the present disclosure also does not limit this aspect. For convenience, the following description is given by assuming that the first indication is carried in a MAC CE.

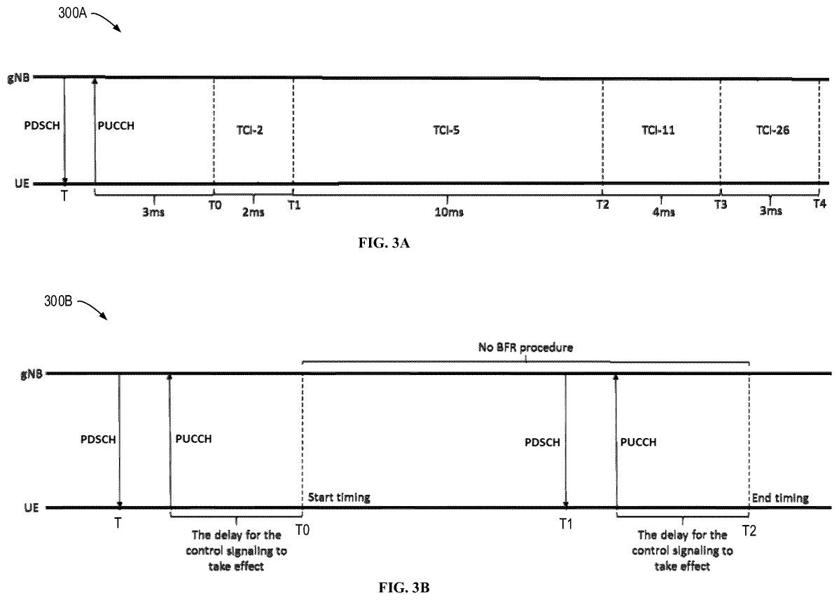

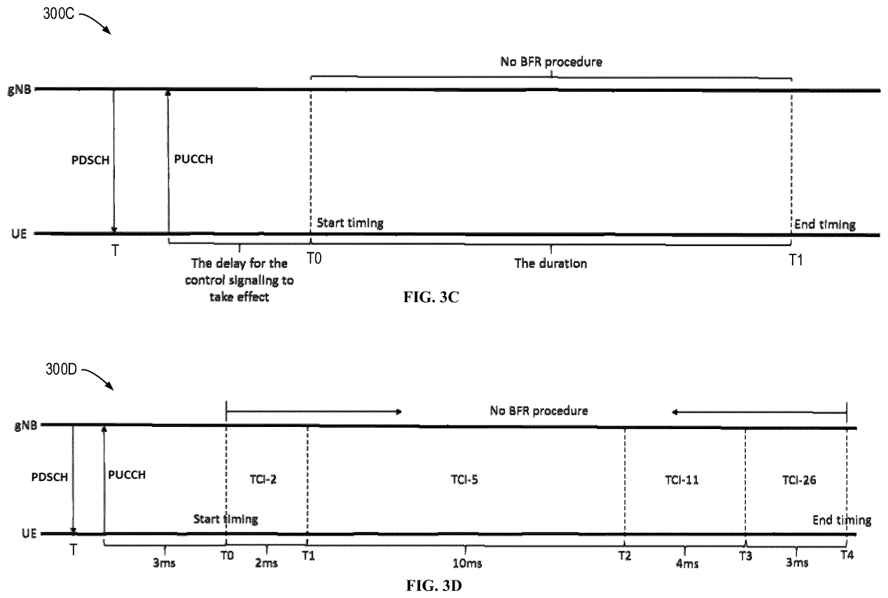

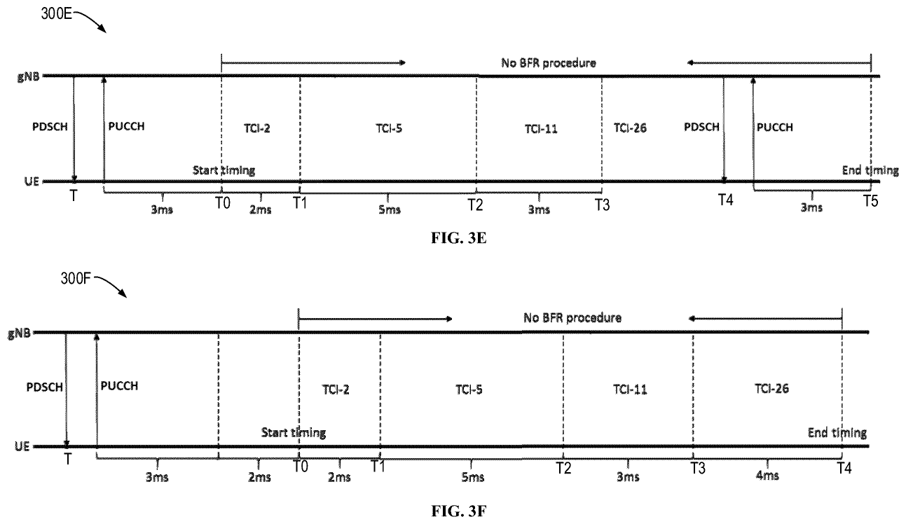

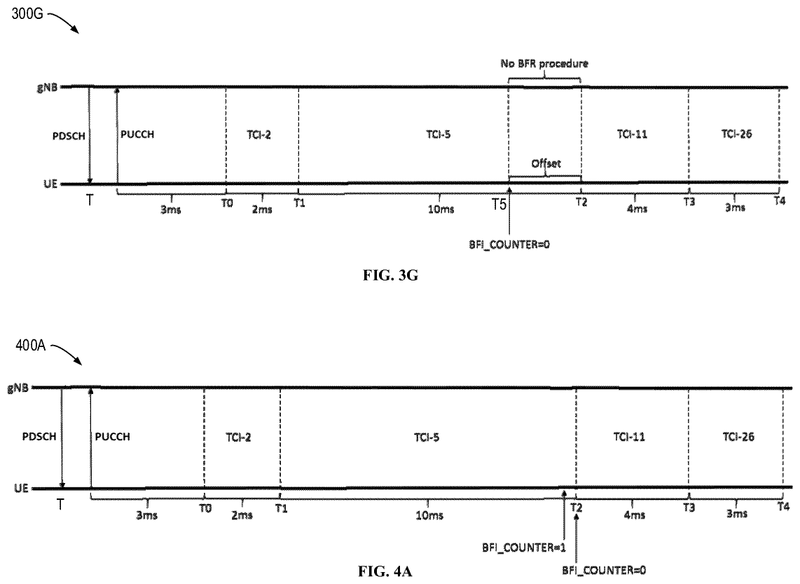

FIG. 3A illustrates a schematic diagram 300A illustrating an example configuration of a set of TCI states according to some embodiments of the present disclosure. For convenience, the network device 120 is shown as gNB and the terminal device 110 is shown as UE.

Assuming that the UE is not provided with a q0 explicitly by the gNB in a bandwidth part (BWP) of a serving cell. The UE is provided with a q1 explicitly by the gNB in the BWP of the serving cell. The serving cell may be a PCell, PSCell or SCell. The UE needs to determine BFD-RSs in the BWP of the serving cell according to the beams of CORESETs (i.e., P CSI-RS resources associated with the TCI states applied to CORESETs) configured in the BWP. One of the CORESETs is CORESET-1.

As shown in FIG. 3A, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a hybrid automatic repeat request-acknowledgement (HARQ-ACK) corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms). It is to be understood that FIG. 3A is merely an example, and is not intended for limitation.

Return to FIG. 2, the terminal device 110 determines 220 whether a BFR procedure is to be performed in application time associated with at least one TCI state in the set of TCI states. If no BFR procedure is to be performed, the terminal device 110 stops 230 the BFR procedure in the application time associated with the at least one TCI state. If the BFR procedure is to be performed, the terminal device 110 performs 240 the BFR procedure in the application time associated with the at least one TCI state.

Correspondingly, the network device 120 also determines 250 whether a BFR procedure is to be performed in application time associated with at least one TCI state in the set of TCI states. If no BFR procedure is to be performed, the network device 120 stops 260 the BFR procedure in the application time associated with the at least one TCI state. If the BFR procedure is to be performed, the network device 120 performs 270 the BFR procedure in the application time associated with the at least one TCI state.

In this way, the BFR procedure may be not always performed, and only performed when a predetermined condition is satisfied. Accordingly, power consumption of a terminal device and BFR related resource overhead may be reduced. For illustration, some example embodiments will be described below.

### 1. No BFR Procedure

In this aspect, the terminal device 110 may not perform a BFR procedure or one or more steps in the BFR procedure during a certain period of time. Specifically, based on AI or ML technology, the network device 120 may predict the beams applied for the terminal device 110 in a certain period of time in the future easily, which greatly reduces probability of a BFR procedure or even no BFR procedure. Therefore, during this period of time, in order to save the terminal device 110's power consumption and BFR related resource overhead (e.g., BFD-RS, NBI-RS), the terminal device 110 may not need to perform a BFR procedure. Some example embodiments will be described below in connection with Embodiments 1 to 10.

### Embodiment 1

In this embodiment, the network device 120 may transmit an indication (for convenience, also referred to as a second indication herein) indicating whether a beam prediction is enabled or disabled. If determining that no BFR procedure is to be performed, the network device 120 may transmit the second indication indicating the enabling of the beam prediction. If determining that the BFR procedure is to be performed, the network device 120 may transmit the second indication indicating the disabling of the beam prediction.

The terminal device 110 may receive, from the network device 120, the second indication indicating whether a beam prediction is enabled or disabled. For example, the second indication may be carried by a RRC signaling, a MAC CE or DCI. Of course, any other suitable ways are also feasible. If the second indication indicates that the beam prediction is enabled, the terminal device 110 may determine that the BFR procedure is not to be performed in application time associated with each TCI state in the set of TCI states. If the second indication indicates that the beam prediction is disabled, the terminal device 110 may determine that the BFR procedure is to be performed in application time associated with each TCI state in the set of TCI states.

In some embodiments, a start timing for stopping the BFR procedure may be the first symbol where the second indication enabling the beam prediction takes effect and an end timing for stopping the BFR procedure may be the first symbol where the second indication disabling the beam prediction takes effect. For illustration, an example is described in connection with FIG. 3B.

FIG. 3B illustrates a schematic diagram 300B illustrating an example management of a BFR procedure according to some embodiments of the present disclosure. For convenience, the network device 120 is shown as gNB and the terminal device 110 is shown as UE. As shown in FIG. 3B, at a timing T, the gNB may transmit, to the UE, a PDSCH carrying the second indication enabling a beam prediction. As a response, the UE may transmit, to the gNB, a PUCCH carrying a HARQ-ACK corresponding to the PDSCH. At a timing T0 after a delay D1 for the second indication to take effect, the UE may stop the BFR procedure. Still with reference to FIG. 3B, at a timing T1, the gNB may transmit, to the UE, another PDSCH carrying the second indication disabling a beam prediction. As a response, the UE may transmit, to the gNB, another PUCCH carrying a HARQ-ACK corresponding to the other PDSCH. At a timing T2 after a delay D2 for the second indication to take effect, the UE may resume the BFR procedure.

It is to be understood that FIG. 3B is merely an example, and is not intended for limitation. The start timing and end timing may be defined in any other suitable ways, and the present disclosure does not limit this aspect.

### Embodiment 2

In this embodiment, the network device 120 may transmit, to the terminal device 110, an indication (for convenience, also referred to as a third indication herein) indicating a duration in which the beam prediction is to be applied. For example, the third indication may be carried by a RRC signaling, a MAC CE or DCI. Of course, any other suitable ways are also feasible. Based on the third indication, the terminal device 110 may determine that the BFR procedure is not to be performed for the duration.

In some embodiments, a start timing for stopping the BFR procedure may be the first symbol of the duration and an end timing for stopping the BFR procedure may be the last symbol for the duration. For illustration, an example is described in connection with FIG. 3C.

FIG. 3C illustrates a schematic diagram 300C illustrating an example management of a BFR procedure according to some embodiments of the present disclosure. For convenience, the network device 120 is shown as gNB and the terminal device 110 is shown as UE. As shown in FIG. 3C, at a timing T, the gNB may transmit, to the UE, a PDSCH carrying the third indication indicating the duration. As a response, the UE may transmit, to the gNB, a PUCCH carrying a HARQ-ACK corresponding to the PDSCH. At a timing T0 after a delay for the third indication to take effect, the UE may stop the BFR procedure. At a timing T1 after the duration, the UE may resume the BFR procedure.

It is to be understood that FIG. 3C is merely an example, and is not intended for limitation. The start timing and end timing may be defined in any other suitable ways, and the present disclosure does not limit this aspect.

### Embodiment 3

In this embodiment, the network device 120 may transmit, to the terminal device 110, an indication (for convenience, also referred to as a fourth indication herein) indicating a duration (for convenience, also referred to as a first duration herein) in which a data collection stage for the beam prediction is to be performed and a duration (for convenience, also referred to as a second duration herein) in which at least one of an inference or application stage for the beam prediction is to be performed. For example, the fourth indication may be carried by a RRC signaling, a MAC CE or DCI. Of course, any other suitable ways are also feasible. Based on the fourth indication, the terminal device 110 may determine that the BFR procedure is not to be performed for at least one of the first duration or the second duration.

In some embodiments, a start timing for stopping the BFR procedure may be the first symbol of the first duration and an end timing for stopping the BFR procedure may be the last symbol for the first duration. In some embodiments, a start timing for stopping the BFR procedure may be the first symbol of the second duration and an end timing for stopping the BFR procedure may be the last symbol for the second duration. In some embodiments, a start timing for stopping the BFR procedure may be the first symbol of the first duration and an end timing for stopping the BFR procedure may be the last symbol for the second duration. It is to be understood that the start timing and end timing may be defined in any other suitable ways, and the present disclosure does not limit this aspect.

### Embodiment 4

In this embodiment, the network device 120 may transmit an indication (for convenience, also referred to as a fifth indication herein) indicating whether the BFR procedure is enabled or disabled. If determining that no BFR procedure is to be performed, the network device 120 may transmit the fifth indication indicating the disabling of the BFR procedure. If determining that the BFR procedure is to be performed, the network device 120 may transmit the fifth indication indicating the enabling of the BFR procedure.

The terminal device 110 may receive, from the network device 120, an indication (for convenience, also referred to as a fifth indication herein) indicating whether the BFR procedure is enabled or disabled. For example, the fifth indication may be carried by a RRC signaling, a MAC CE or DCI. Of course, any other suitable ways are also feasible. If the fifth indication indicates that the BFR procedure is enabled, the terminal device 110 may determine that the BFR procedure is to be performed. If the fifth indication indicates that the BFR procedure is disabled, the terminal device 110 may determine that the BFR procedure is not to be performed.

In some embodiments, a start timing for stopping the BFR procedure may be the first symbol where the fifth indication disabling the BFR procedure takes effect and an end timing for stopping the BFR procedure may be the first symbol where the fifth indication enabling the BFR procedure takes effect. It is to be understood that the start timing and end timing may be defined in any other suitable ways, and the present disclosure does not limit this aspect.

### Embodiment 5

In this embodiment, the network device 120 may transmit, to the terminal device 110, an indication (for convenience, also referred to as a sixth indication herein) indicating a duration in which the BFR procedure is enabled. For example, the sixth indication may be carried by a RRC signaling, a MAC CE or DCI. Of course, any other suitable ways are also feasible. Based on the sixth indication, the terminal device 110 may determine that the BFR procedure is to be performed for the duration.

In some embodiments, a start timing for stopping the BFR procedure may be the last symbol of the duration and an end timing for stopping the BFR procedure may be the first symbol for the duration. It is to be understood that the start timing and end timing may be defined in any other suitable ways, and the present disclosure does not limit this aspect.

### Embodiment 6

In this embodiment, the network device 120 may transmit, to the terminal device 110, an indication (for convenience, also referred to as a seventh indication herein) indicating a duration in which the BFR procedure is disabled. For example, the seventh indication may be carried by a RRC signaling, a MAC CE or DCI. Of course, any other suitable ways are also feasible. The terminal device 110 may determine that the BFR procedure is not to be performed for the duration.

In some embodiments, a start timing for stopping the BFR procedure may be the first symbol of the duration and an end timing for stopping the BFR procedure may be the last symbol for the duration. It is to be understood that the start timing and end timing may be defined in any other suitable ways, and the present disclosure does not limit this aspect.

### Embodiment 7

In this embodiment, the terminal device 110 may determine that the BFR procedure is not to be performed in application time associated with each TCI state in the set of TCI states, and stop the BFR procedure in the application time associated with each TCI state in the set of TCI states. Correspondingly, the network device 120 may also determine that the BFR procedure is not to be performed in application time associated with each TCI state in the set of TCI states, and stop the BFR procedure in the application time associated with each TCI state in the set of TCI states.

In some embodiments, the first indication indicating the set of TCI states may comprise an application time of the last TCI state in the set of TCI states. In these embodiments, the terminal device 110 may stop the BFR procedure in a time interval from a timing at which the first indication takes effect to a timing at which the application time of the last TCI state ends. For example, a starting timing for stopping the BFR procedure may be the first symbol where the first indication takes effect (i.e., an application timing of a beam indication may be reused), and an end timing for stopping the BFR procedure may be the last symbol corresponding to the application time of the last TCI state or the total application time corresponding to the set of TCI states. For illustration, an example is described in connection with FIG. 3D.

FIG. 3D illustrates a schematic diagram 300D illustrating an example management of a BFR procedure according to some embodiments of the present disclosure. For convenience, the network device 120 is shown as gNB and the terminal device 110 is shown as UE. As shown in FIG. 3D, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms). In this example, the UE may stop the BFR procedure from T0 to T4. It is to be understood that FIG. 3D is merely an example, and is not intended for limitation. The start timing and end timing may be defined in any other suitable ways, and the present disclosure does not limit this aspect.

In some embodiments, the first indication indicating the set of TCI states may not comprise an application time of the last TCI state in the set of TCI states. In these embodiments, the terminal device 110 may stop the BFR procedure in a time interval from a timing at which the first indication takes effect to a timing corresponding to the last symbol before another set of TCI states is applied for the CORESET. For example, a starting timing for stopping the BFR procedure may be the first symbol where the first indication takes effect (i.e., an application timing of a beam indication may be reused), and an end timing for stopping the BFR procedure may be the last symbol before the terminal device 110 applies one or more TCI states indicated by a control signaling to the CORESET, the control signaling indicating no application time. For illustration, an example is described in connection with FIG. 3E.

FIG. 3E illustrates a schematic diagram 300E illustrating an example management of a BFR procedure according to some embodiments of the present disclosure. For convenience, the network device 120 is shown as gNB and the terminal device 110 is shown as UE. As shown in FIG. 3E, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, and TCI-26. The last TCI state TCI-26 is not indicated with application time.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3.

At a timing T4, the gNB may transmit, to the UE, another PDSCH carrying a MAC CE indicating other one or more TCI states for CORESET-1. In this example, the CORESET-1 is indicated a TCI set including 1 TCI state: TCI-30. Upon reception of the other PDSCH, the UE may transmit, to the gNB, another PUCCH carrying a HARQ-ACK corresponding to the other PDSCH. Assuming that a delay for the MAC CE to take effect is 3 ms. At a timing T5 after 3 ms, the TCI-30 may be applied to the CORESET-1. In this case, the UE may stop the BFR procedure from T0 to T5. It is to be understood that FIG. 3E is merely an example, and is not intended for limitation. The start timing and end timing may be defined in any other suitable ways, and the present disclosure does not limit this aspect.

In some embodiments, the first indication indicating the set of TCI states may comprise an application time of the last TCI state in the set of TCI states and a time offset. In these embodiments, a starting timing for stopping the BFR procedure may be the first symbol after the time offset from a timing at which the first indication takes effect. The end timing for stopping the BFR procedure may be the last symbol corresponding to the application time of the last TCI state or the total application time corresponding to the set of TCI states. For illustration, an example is described in connection with FIG. 3F.

FIG. 3F illustrates a schematic diagram 300F illustrating an example management of a BFR procedure according to some embodiments of the present disclosure. For convenience, the network device 120 is shown as gNB and the terminal device 110 is shown as UE. As shown in FIG. 3F, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms. The time offset is 2 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms plus a time offset of 2 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms). In this example, the UE may stop the BFR procedure from T0 to T4. It is to be understood that FIG. 3F is merely an example, and is not intended for limitation. The start timing and end timing may be defined in any other suitable ways, and the present disclosure does not limit this aspect.

In some embodiments, the first indication indicating the set of TCI states may comprise a time offset and not comprise an application time of the last TCI state in the set of TCI states. In these embodiments, a starting timing for stopping the BFR procedure may be the first symbol after the time offset from a timing at which the first indication takes effect. The end timing for stopping the BFR procedure may be the last symbol before the terminal device 110 applies one or more TCI states indicated by a control signaling to the CORESET, the control signaling indicating no application time.

### Embodiment 8

In this embodiment, the terminal device 110 may determine that the BFR procedure is not to be performed in application time associated with a part of the set of TCI states, and stop the BFR procedure in the application time associated with the part of the set of TCI states.

In some embodiments, the terminal device 110 may determine whether application time associated with a TCI state in the set of TCI states is shorter than or equal to threshold time. If the application time associated with the TCI state is shorter than or equal to the threshold time, the terminal device 110 may determine that the BFR procedure is not to be performed in the application time associated with the TCI state. If the application time associated with the TCI state is longer than the threshold time, the terminal device 110 may determine that the BFR procedure is to be performed in the application time associated with the TCI state. In other words, the terminal device 110 may not perform the BFR procedure during the application time of the TCI state having the short “residence time”. In some embodiments, the threshold time may be configured by the network device 120 and determined based on a capability reported by the terminal device 110. For example, assuming that the threshold time is set to 5 ms. In the example of FIG. 3F, the terminal device 110 only needs to perform the BFR procedure in the application time of TCI-5.

In some embodiments, the terminal device 110 may receive, from the network device 120, information indicating a first subset of TCI states and a second subset of TCI states. The terminal device 110 may determine, based on the information and from the set of TCI states, the first subset of TCI states and the second subset of TCI states, and determine that the BFR procedure is to be performed in application time associated with the first subset of TCI states and that no BFR procedure is to be performed in application time associated with the second subset of TCI states.

For example, A (A≥1) consecutive TCI states in the set of TCI states is regarded as a group. The interval between groups is B (B≥0) TCI states. Additionally, a starting offset may be indicated which is used to determine the first group. Assuming that the starting offset is set to 2, A is set to 1, and B is set to 1. In the example of FIG. 3F, the terminal device 110 only needs to perform the BFR procedure in the application time of TCI-5 and TCI-26. In some embodiments, the A, B or starting offset may be configured by the network device 120 and determined based on a capability reported by the terminal device 110.

Correspondingly, the network device 120 may also perform similar operations.

### Embodiment 9

In this embodiment, the terminal device 110 may determine whether the BFR procedure is to be performed based on predefined conditions for a counter (BFI_COUNTER) configured for beam failure indication (BFI).

In some embodiments, the terminal device 110 may determine whether a value of the counter configured for BFI is smaller than or equal to a predetermined value at a time offset before an expiration of a TCI state in the set of TCI states. If the value of the counter is smaller than or equal to the predetermined value, the terminal device 110 may determine that the BFR procedure is not to be performed in application time associated with the TCI state. If the value of the counter is greater than the predetermined value, the terminal device 110 may determine that the BFR procedure is to be performed in application time associated with the TCI state.

In some embodiments, the time offset may be determined according to a time interval from declaration of a beam failure to effectiveness of a new beam. In some embodiments, the time offset may be configured by the network device 120 and determined based on a capability reported by the terminal device 110.

In other words, if BFI_COUNTER is equal to 0 or is not equal to beamFailureInstanceMaxCount, the terminal device 110 does not need to perform the BFR procedure during the time period of the time offset. For illustration, an example is described in connection with FIG. 3G. Assuming that the value of beamFailureInstanceMaxCount is 2.

FIG. 3G illustrates a schematic diagram 300G illustrating an example management of a BFR procedure according to some embodiments of the present disclosure. For convenience, the network device 120 is shown as gNB and the terminal device 110 is shown as UE. As shown in FIG. 3G, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms). In this example, BFI_COUNTER=0 at the time offset before T2, and thus the UE may stop the BFR procedure during the time offset before T2. It is to be understood that FIG. 3G is merely an example, and is not intended for limitation.

Correspondingly, the network device 120 may also perform similar operations.

### Embodiment 10

In this embodiment, since the BFI event will be informed from a lower layer to a higher layer of the terminal device 110 in BFD procedure, the behavior of stopping the BFR procedure also needs to be indicated to the higher layer.

In some embodiments, the terminal device 110 may transmit, from the lower layer to the higher layer, an indication (for convenience, also referred to as an eighth indication herein) indicating the stopping of the BFR procedure, and set, by the higher layer, a counter (BFI_COUNTER) configured for BFI to zero. In some embodiments, the lower layer may comprise a physical layer of the terminal device 110, and the higher layer may comprise a medium access control (MAC) layer, a radio link control (RLC) layer, a packet data convergence protocol (PDCP) layer or service data application protocol (SDAP) layer of the terminal device 110.

So far, a management of a BFR procedure is achieved in which the BFR procedure is not to be performed in application time associated with at least one TCI state. In this way, a conflict between a new beam identified in a BFR procedure and a switched beam in TCI set may be avoided, and unnecessary power consumption of a terminal device and overhead of resources required for reporting the new beam may be reduced.

### 2. Conditional BFR Procedure

In this aspect, the terminal device 110 may initialize a BFR procedure in application time associated with the set of TCI states. Specifically, based on AI or ML technology, the network device 120 may predict the beams applied for the terminal device 110 in a certain period of time in the future easily, which greatly reduces probability of a BFR procedure or even no BFR procedure. However, the most accurate prediction method may not avoid the occurrence of unexpected events such as obstacles, a rotation of the terminal device 110, etc., and these events may not be considered during AI or ML training. Therefore, in order to ensure very accurate beam tracking, the terminal device 110 needs to perform the BFR procedure even during the above period of time. Some example embodiments will be described below in connection with Embodiments 11 to 16.

### Embodiment 11

In this embodiment, if any of BFD-RSs is changed or switched, the terminal device 110 may determine that the BFR procedure is to be performed. The terminal device 110 may perform the BFR procedure by setting a BFI_COUNTER to zero. In other words, if a beam or TCI state applied to the CORESET is switched, the BFI_COUNTER is set to zero.

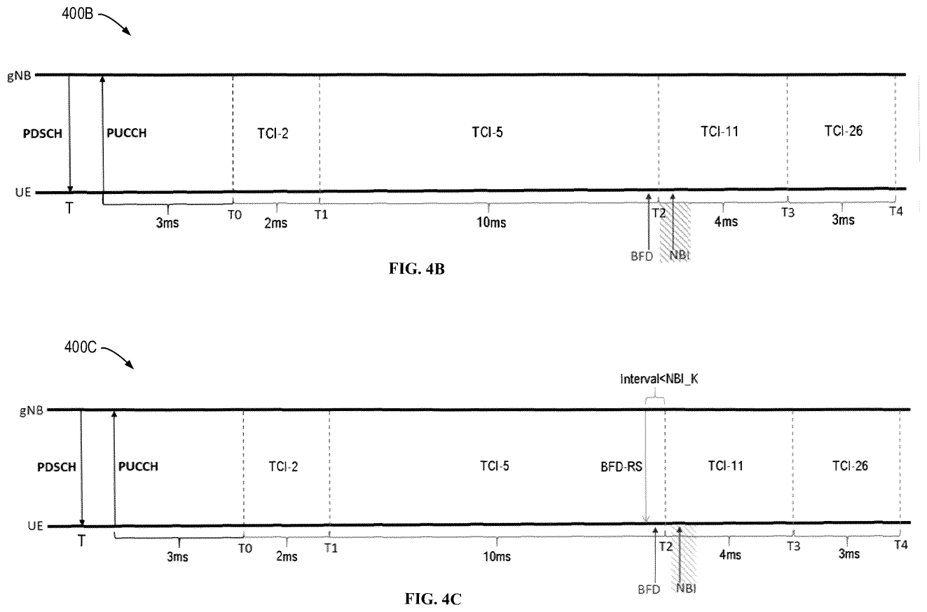

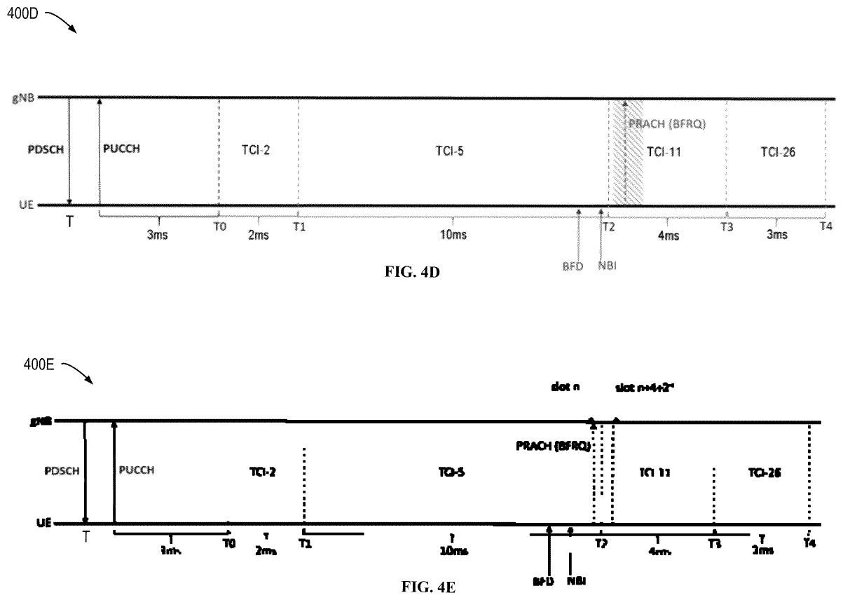

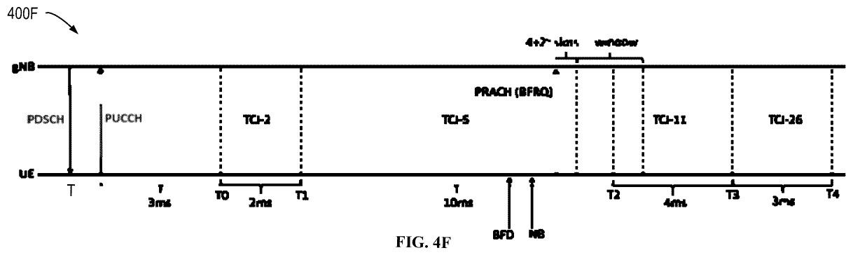

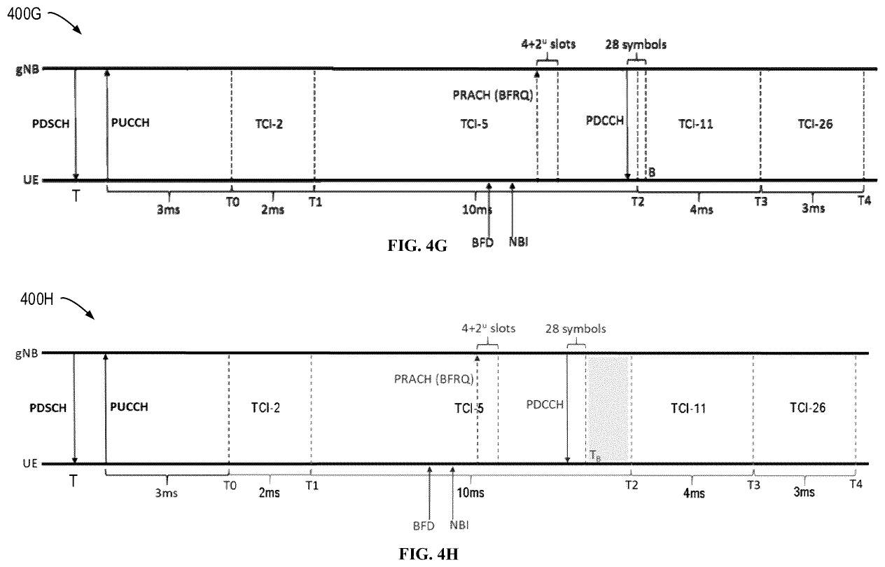

FIG. 4A illustrates a schematic diagram 400A illustrating an example management of a BFR procedure according to some embodiments of the present disclosure. For convenience, the network device 120 is shown as gNB and the terminal device 110 is shown as UE. As shown in FIG. 4A, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, “BFI_COUNTER=1” is declared before T2. But the beam of the CORESET-1 needs to be switched to the beam corresponding to TCI-11 after T2. At this time, BFI_COUNTER needs to be set to zero. It is to be understood that FIG. 4A is merely an example, and is not intended for limitation.

In this way, BFD or BFR procedure may be done based on the currently applied (or used or valid) and fixed (or constant) beams, and thus a compatibility with the existing specification may be well achieved.

### Embodiment 12

In this embodiment, the terminal device 110 may not continue to perform NBI. NBI means that the new beam is provided from the lower layer of the terminal device 110 to the higher layer of the terminal device 110. In other words, the terminal device 110 may provide the new beam (q_new) to the higher layer if a predefined condition is satisfied.

In some embodiments, if any of BFD-RSs is not changed no later than NBI, the terminal device 110 may determine that the BFR procedure is to be performed. The terminal device 110 may perform the BFR procedure by indicating the new beam from the lower layer of the terminal device 110 to the higher layer of the terminal device 110. In other words, if any of BFD-RSs is not changed or switched no later than NBI, the terminal device 110 may provide the new beam to the higher layer.

FIG. 4B illustrates a schematic diagram 400B illustrating an example management of a BFR procedure according to some embodiments of the present disclosure. For convenience, the network device 120 is shown as gNB and the terminal device 110 is shown as UE. As shown in FIG. 4B, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, a beam failure event is declared before T2 (i.e., BFD). According to the existing BFR procedure, the UE will determine the new beam from the q1 and provide it to the higher layer after T2. But the beam of the CORESET-1 needs to be switched to the beam corresponding to TCI-11 after T2, and the BFD-RS has changed accordingly. It means that the UE has known and switched a “new beam” (corresponding to TCI-11), so the UE does not need to provide the new beam to the higher layer. It is to be understood that FIG. 4B is merely an example, and is not intended for limitation.

In some alternative embodiments, if any of BFD-RSs is changed no later than NBI, and the switched BFD-RS is different from the new beam, the terminal device 110 may determine that the BFR procedure is to be performed. The terminal device 110 may perform the BFR procedure by indicating the new beam from the lower layer of the terminal device 110 to the higher layer of the terminal device 110. In other words, if any of BFD-RSs is changed no later than NBI and the switched BFD-RS is different from the new beam,, the terminal device 110 may provide the new beam to the higher layer.

For example, if the switched BFD-RS (in the example of FIG. 4B, the beam corresponding to TCI-11) is the same as the determined new beam, it is totally unnecessary that the UE provides the determined new beam to the higher layer. Here, “the switched BFD-RS is the same as the new beam” means that the switched BFD-RS is the same as or quasi co-located with the RS corresponding to the new beam.

In some alternative embodiments, if a time interval between the detection of the beam failure and a switching from the TCI state to another TCI state is larger than or equal to a threshold interval (denoted as NBI_K herein), the terminal device 110 may determine that the BFR procedure is to be performed. In some embodiments, the threshold interval may be configured by the network device 120 and determined according to a capability reported by the terminal device 110. The terminal device 110 may perform the BFR procedure by indicating the new beam from the lower layer of the terminal device 110 to the higher layer of the terminal device 110. In other words, if the time interval is larger than or equal to the threshold interval, the terminal device 110 may provide the new beam to the higher layer.

In other words, the time interval may refer to an interval between the last symbol of the recent BFD-RS and the first symbol of application time associated with the first TCI state after the recent BFD-RS in the set of TCI states. For illustration, an example is described in connection with FIG. 4C.

FIG. 4C illustrates a schematic diagram 400C illustrating an example management of a BFR procedure according to some embodiments of the present disclosure. For convenience, the network device 120 is shown as gNB and the terminal device 110 is shown as UE. As shown in FIG. 4C, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

As shown in FIG. 4C, an interval between the recent BFD-RS with respect to the BFD and T2 is smaller than NBI_K, so NBI is not provided from the lower layer to the higher layer.

For example, NBI_K may be determined according to a time interval from the declaration of beam failure to the effectiveness of the new beam. For example, at least for PCell or PSCell, NBI_K may be determined according to: the delay of NBI, the delay and window of BFRR, the delay of applying the new beam. Specifically, the delay of NBI refers to the required time for determining the new beam and it is reported by the UE (as capability), the delay of BFRR is 4+2^{μ} slots after the PRACH transmission, the window of BFRR is configured by the gNB, the delay of applying the new beam is K (e.g., 28) symbols. It is to be understood that FIG. 4C is merely an example, and is not intended for limitation.

In this way, a conflict between the switched beam and the new beam may be resolved and unnecessary power consumption of a terminal device may be reduced.

### Embodiment 13

In this embodiment, the terminal device 110 may not continue to perform BFRQ. In other words, the terminal device 110 may report the new beam to the network device 120 if a predefined condition is satisfied.

In some embodiments, if any of BFD-RSs is not changed no later than an uplink resource allocated for transmission of a BFR request, the terminal device 110 may determine that the BFR procedure is to be performed. The terminal device 110 may perform the BFR procedure by transmitting, to the network device 120, the BFR request comprising information of the new beam. In other words, if any of BFD-RSs is not changed no later than the uplink resource, the terminal device 110 may report the new beam to the network device 120.

FIG. 4D illustrates a schematic diagram 400D illustrating an example management of a BFR procedure according to some embodiments of the present disclosure. For convenience, the network device 120 is shown as gNB and the terminal device 110 is shown as UE. As shown in FIG. 4D, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, a beam failure event is declared before T2 (i.e., BFD) and a new beam is identified before T2 (i.e., NBI). According to the existing BFR procedure, the UE will report the new beam to the gNB in the allocated uplink resource (e.g., PRACH if PCell/PSCell, PUCCH/PUSCH if SCell). The first or last symbol of the allocated uplink resource may be located after T2. But the beam of the CORESET-1 needs to be switched to the beam corresponding to TCI-11 after T2, and the BFD-RS has changed accordingly. It means that the UE has known and switched a “new beam” (corresponding to TCI-11), so the UE does not need to report the new beam to the gNB. It is to be understood that FIG. 4D is merely an example, and is not intended for limitation.

In some alternative embodiments, if any of BFD-RSs is changed no later than an uplink resource allocated for transmission of a BFR request, and the switched BFD-RS is different from the new beam, the terminal device 110 may determine that the BFR procedure is to be performed. The terminal device 110 may perform the BFR procedure by transmitting, to the network device 120, the BFR request comprising information of the new beam. In other words, if any of BFD-RSs is changed no later than the uplink resource and the switched BFD-RS is different from the new beam, the terminal device 110 may report the new beam to the network device 120.

For example, if the switched BFD-RS (in the example of FIG. 4B, the beam corresponding to TCI-11) is the same as the identified new beam, it is totally unnecessary that the UE reports the identified new beam to the network device 120.

In some alternative embodiments, if a time interval between the detection of the beam failure and a switching from the TCI state to another TCI state is larger than or equal to a threshold interval (denoted as BFRQ_K herein), the terminal device 110 may determine that the BFR procedure is to be performed. In some embodiments, the threshold interval BFRQ_K may be the same as NBI_K. In some embodiments, the threshold interval BFRQ_K may be different from NBI_K.

In this way, a conflict between the switched beam and the new beam may be resolved, and unnecessary power consumption of a terminal device and overhead of reporting resources may be reduced.

### Embodiment 14

In this embodiment, the terminal device 110 may not continue to monitor BFRR. In other words, if a predefined condition is satisfied, the terminal device 110 may start to monitor a response to a BFR request.

In some embodiments, the terminal device 110 may start to monitor the response to the BFR request at a slot (for convenience, also referred to as a second slot herein), the slot being later than a slot (for convenience, also referred to as a first slot herein) for transmission of the BFR request by a period of time. For example, if any of BFD-RSs is not changed no later than the period of time, the terminal device 110 may determine that the BFR procedure is to be performed. The terminal device 110 may perform the BFR procedure by monitoring, at the second slot, the response to the BFR request. In other words, if any of BFD-RSs is not changed no later than the period of time, the terminal device 110 may need to monitor BFRR.

Correspondingly, the network device 120 may determine that the BFR procedure is to be performed if no BFD-RS is changed no later than the period of time after a reception of a BFR request in the first slot, and transmit the response to the BFR request to the terminal device 110 at the second slot.

FIG. 4E illustrates a schematic diagram 400E illustrating an example management of a BFR procedure according to some embodiments of the present disclosure. For convenience, the network device 120 is shown as gNB and the terminal device 110 is shown as UE. As shown in FIG. 4E, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, the UE reports the identified new beam in PRACH transmission in slot n. According to the existing specification, the UE will monitor BFRR in slot n+4+2^{μ}. But the beam of CORESET-1 is switched to TCI-11 before slot n+4+2^{μ}, which means that the UE has known and switched a “new beam” (corresponding to TCI-11), so the UE does not need to monitor BFRR. It is to be understood that FIG. 4E is merely an example, and is not intended for limitation.

In some alternative embodiments, the terminal device 110 may start to monitor the response to the BFR request within a time window. The time window is configured for the monitoring of the response to the BFR request. For example, if any of BFR-RSs is not changed within the time window or if any of BFR-RSs is not changed no later than the last symbol of the time window, the terminal device 110 may determine that the BFR procedure is to be performed. The terminal device 110 may perform the BFR procedure by monitoring the response to the BFR request within the time window. In other words, if any of BFD-RSs is not changed within the time window, the terminal device 110 may need to monitor BFRR.

Correspondingly, the network device 120 may determine that the BFR procedure is to be performed if no BFD-RS is changed within the time window, and transmit the response to the BFR request to the terminal device 110 within the time window.

FIG. 4F illustrates a schematic diagram 400F illustrating an example management of a BFR procedure according to some embodiments of the present disclosure. For convenience, the network device 120 is shown as gNB and the terminal device 110 is shown as UE. As shown in FIG. 4F, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, as shown in FIG. 4F, the UE reports the identified new beam before T2 (i.e., PRACH (BFRQ)). According to the existing specification, the UE will monitor BFRR within the window. But the beam of CORESET-1 is switched to TCI-11 within the window, which means that the UE has known and switched a “new beam” (corresponding to TCI-11), so the UE does not need to monitor BFRR. It is to be understood that FIG. 4F is merely an example, and is not intended for limitation.

In this way, a conflict between the switched beam and the new beam may be resolved, and unnecessary power consumption of a terminal device may be reduced.

### Embodiment 15

In this embodiment, the terminal device 110 may not apply a new beam. In other words, if a predefined condition is satisfied, the terminal device 110 may apply the new beam.

In some embodiments, if any of BFD-RSs is not changed within a period of time corresponding to a predetermined number (denoted as K herein) of symbols, or if any of BFD-RSs is not changed no later than the last symbol of the K symbols after the last symbol of a PDCCH reception as BFRR, the terminal device 110 may determine that the BFR procedure is to be performed. The terminal device 110 may perform the BFR procedure by applying the new beam for signal transmission after the predetermined number of symbols from the reception of BFRR.

In other words, if any of BFD-RSs is not changed within the period of time, the terminal device 110 may apply the new beam for signal transmission. For example, the signal transmission may comprise at least one of a PDCCH transmission in the CORESET, a PDSCH transmission, a PUCCH transmission, or a transmission of a reference signal such as CSI-RS or sounding reference signal (SRS). Of course, any other suitable transmissions are also feasible.

Correspondingly, the network device 120 may determine that the BFR procedure is to be performed if no BFD-RS is changed within the period of time. The network device 120 may apply the new beam for signal transmission after the predetermined number of symbols from a transmission of BFRR.

FIG. 4G illustrates a schematic diagram 400E illustrating an example management of a BFR procedure according to some embodiments of the present disclosure. For convenience, the network device 120 is shown as gNB and the terminal device 110 is shown as UE. As shown in FIG. 4G, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, as shown in FIG. 4G, the UE monitored the first PDCCH (BFRR) corresponding the new beam in CORESET-BFR before T2. According to the existing specification, the UE will apply monitor the new beam after 28 symbols from the last symbol of the PDCCH, i.e., after B. But the beam of CORESET-1 is switched to TCI-11 before B, which means that the UE has known and switched a “new beam” (corresponding to TCI-11), so the UE does not need to apply the new beam. It is to be understood that FIG. 4E is merely an example, and is not intended for limitation.

In this way, a conflict between the switched beam and the new beam may be resolved.

### Embodiment 16

In this embodiment, the terminal device 110 may not apply a new beam after a beam switching. In other words, if a predefined condition is satisfied, the terminal device 110 may apply the new beam until the terminal device 110 switches to another beam applied to a downlink or uplink signal, and the switched beam is different from the new beam.

In some embodiments, the terminal device 110 may determine that the BFR procedure is to be performed until a TCI state is changed and a beam corresponding to the changed TCI state is different from a beam (i.e., the new beam) indicated in a BFRQ. The terminal device 110 may perform the BFR procedure by applying the new beam for signal transmission after a predetermined number of symbols from a reception of a BFRR to the BFRQ. For example, the signal transmission may comprise at least one of a PDCCH transmission in the CORESET, a PDSCH transmission, a PUCCH transmission, or a transmission of a reference signal such as CSI-RS or SRS. Of course, any other suitable transmissions are also feasible.

Correspondingly, the network device 120 may determine that the BFR procedure is to be performed until a TCI state is changed and a beam corresponding to the changed TCI state is different from a beam (i.e., the new beam) indicated in a BFR request from the terminal device 110. The network device 120 may apply the new beam for signal transmission after the predetermined number of symbols from a transmission of BFRR.

FIG. 4H illustrates a schematic diagram 400H illustrating an example management of a BFR procedure according to some embodiments of the present disclosure. For convenience, the network device 120 is shown as gNB and the terminal device 110 is shown as UE. As shown in FIG. 4H, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, as shown in FIG. 4H, if the beam corresponding to TCI-11 is different from the new beam, the UE will apply the new beam to CORESET-1 from TB to T2. It is to be understood that FIG. 4E is merely an example, and is not intended for limitation.

In some embodiments, the terminal device 110 may apply the new beam until the terminal device 110 switches to a predetermined TCI state in the set of TCI states after the applying of the new beam. For example, the terminal device 110 may apply the new beam until the terminal device 110 switches to the N-th (N≥1) TCI state in the set of TCI states after an application timing of the new beam. In the example of FIG. 4H, if N=1, the new beam will be applied to from TB to T2. If N=2, the new beam will be applied to from TB to T3.

Correspondingly, the network device 120 may also apply the new beam until the network device 120 switches to a predetermined TCI state in the set of TCI states after the applying of the new beam.

In this way, an application time range of the new beam may be clarified, and a conflict between the switched beam and the new beam may be resolved.

### 3. Continued BFR Procedure

In this aspect, the terminal device 110 may continue to perform a BFR procedure in application time associated with the set of TCI states. Specifically, The above Embodiments 11 to 16 are described based on the fact that the terminal device 110 does not need to perform the BFR procedure. On the other hand, it may also be considered how to use the set of TCI states on the basis of ensuring the complete BFR procedure. It means that whether any of BFD-RSs is switched or not, the terminal device 110 may continue to perform the current BFR procedure. Some example embodiments will be described below in connection with Embodiment 17.

### Embodiment 17

In this embodiment, one or more TCI states in the set of TCI states may be dropped or omitted. The one or more TCI states are different from the current TCI state applied for the CORESET-1.

In some embodiments, the terminal device 110 may determine that the BFR procedure is to be performed and the terminal device 110 may drop or omit a subset of TCI states in the set of TCI states, the subset of TCI states being to be applied after a beam failure. In other words, all remaining one or more TCI states that should have been applied to CORESET-1 after the time corresponding to BFD (i.e., a beam failure event is declared) are dropped or omitted.

Correspondingly, the network device 120 may also drop a subset of TCI states in the set of TCI states, the subset of TCI states being to be applied after a beam failure.

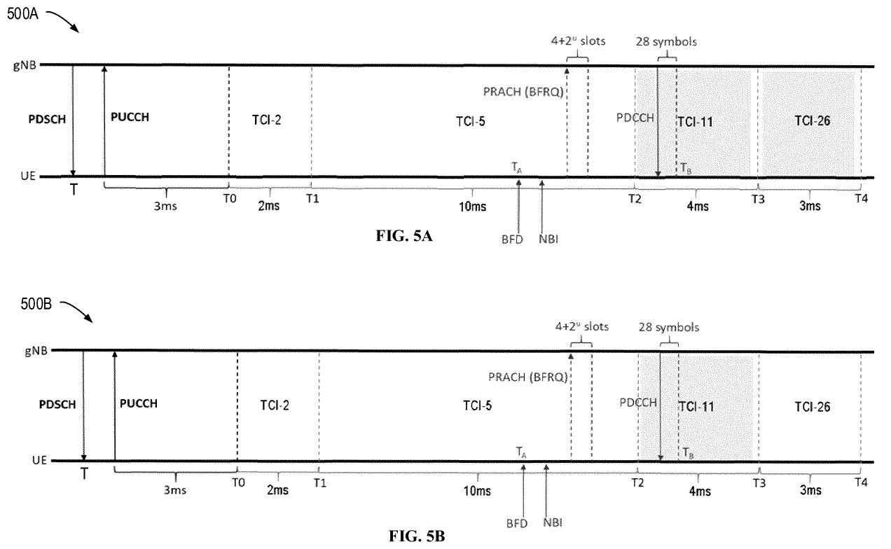

FIG. 5A illustrates a schematic diagram 500A illustrating an example management of a BFR procedure according to some embodiments of the present disclosure. For convenience, the network device 120 is shown as gNB and the terminal device 110 is shown as UE. As shown in FIG. 5A, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, as shown in FIG. 5A, if a beam failure event is declared at TA, the TCI states (i.e., TCI-11 and TCI-26) that should have been applied to CORESET-1 after TA may be dropped or omitted. It is to be understood that FIG. 5A is merely an example, and is not intended for limitation.

In some alternative embodiments, partial remaining TCI states that should have been applied to CORESET-1 after the time corresponding to BFD (i.e., a beam failure event is declared) are dropped or omitted. In some example embodiments, the terminal device 110 may determine that the BFR procedure is to be performed and the terminal device 110 may drop or omit a subset of TCI states in the set of TCI states, the subset of TCI states being determined based on the first TCI state in the set of TCI states to be applied after a beam failure and a TCI state in the set of TCI states to be applied at applying of a beam indicated in a BFR request.

Correspondingly, the network device 120 may also drop a subset of TCI states in the set of TCI states, the subset of TCI states being determined based on the first TCI state in the set of TCI states to be applied after a beam failure and a TCI state in the set of TCI states to be applied at or after applying of a beam indicated in a BFR request.

FIG. 5B illustrates a schematic diagram 500B illustrating an example management of a BFR procedure according to some embodiments of the present disclosure. For convenience, the network device 120 is shown as gNB and the terminal device 110 is shown as UE. As shown in FIG. 5B, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, as shown in FIG. 5B, if a beam failure event is declared at TA, the TCI states from TCI-11 to TCI-11 (i.e., only TCI-11) may be dropped or omitted. It is to be understood that FIG. 5B is merely an example, and is not intended for limitation.

In some example embodiments, the terminal device 110 may determine that the BFR procedure is to be performed and the terminal device 110 may drop or omit a subset of TCI states in the set of TCI states, the subset of TCI states being determined based on the first TCI state in the set of TCI states to be applied after a beam failure and a TCI state in the set of TCI states to be applied after applying of a beam indicated in a BFR request. In this case, in the example of FIG. 5B, if a beam failure event is declared at TA, the TCI states from TCI-11 to TCI-26 may be dropped or omitted.

In this way, the complete BFR procedure is ensured.

### 4. BFD Procedure

Generally, a BFD or BFR procedure is based on the currently applied and fixed beam to the CORESET, which is largely because a network device can only indicate one TCI state for the CORESET to be applied in the next one period of time. The situation where multiple TCI states are indicated at the same time only occurs in the scenario of multi-transmission reception points (multi-TRPs). Accordingly, if the network device indicates a TCI set including multiple TCI states for the CORESET to be applied in the next multiple and consecutive periods of time, a BFD or BFR procedure should be based on the TCI set. In other words, at least during a BFD or BFR procedure, the “one TCI set” or “one beam set” can be regarded as “one TCI” or “one beam”. Otherwise, some problems may be caused.

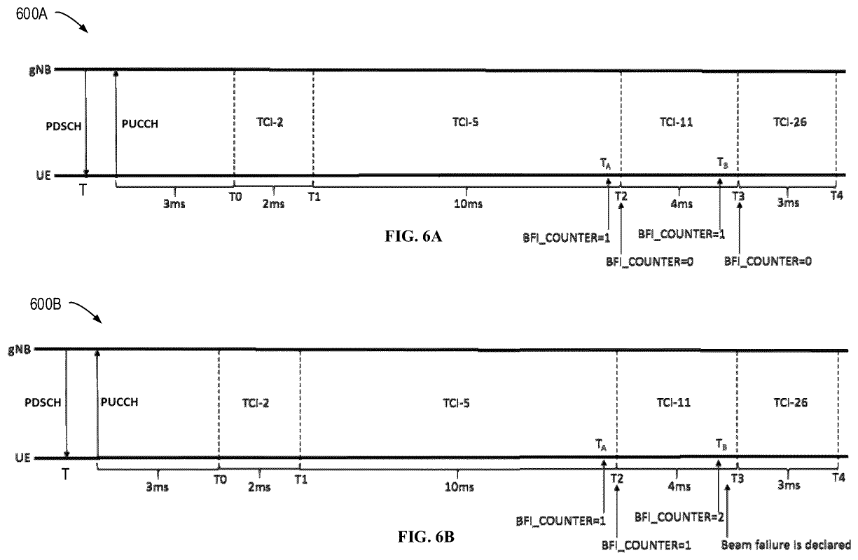

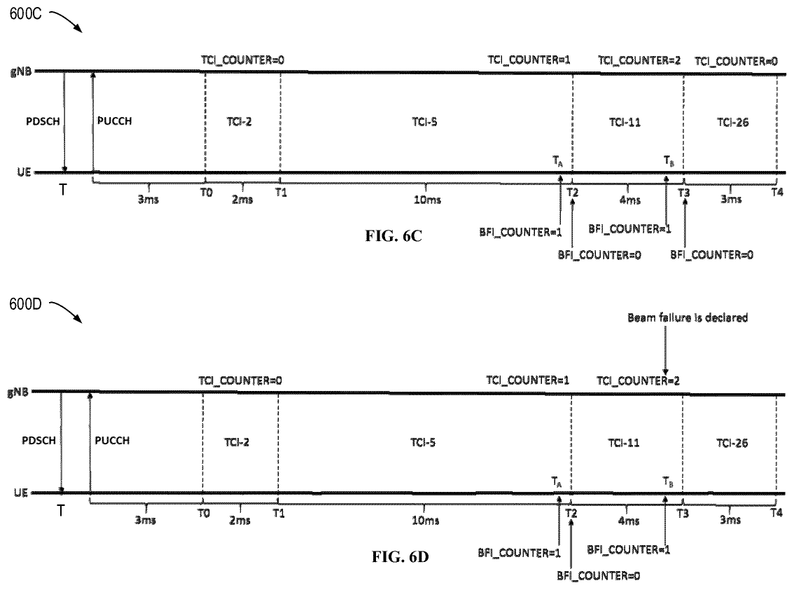

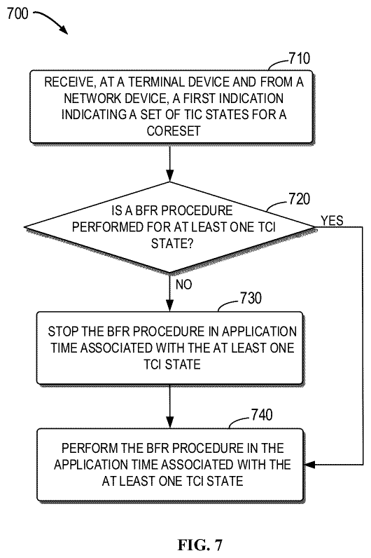

FIG. 6A illustrates a schematic diagram 600A illustrating an example problem of a BFD procedure according to some embodiments of the present disclosure. For convenience, the network device 120 is shown as gNB and the terminal device 110 is shown as UE. As shown in FIG. 6A, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, as shown in FIG. 6A, due to an accidental obstacle before TA, a BFI event (i.e., BFI_COUNTER=1) occurs at TA. Further, the BFD-RS changes with the change of the beam of CORESET (from TCI-5 to TCI-11) at T2, which results in BFI_COUNTER=0. However, because the obstacle may be long-term and uncontemplated (not considered in AI/ML beam prediction in time domain), another BFI event occurs at TB. But, BFI_COUNTER-0 at T3.

It means that a beam failure event may be not declared during the beam quality deterioration. The UE still uses the beams with poor quality. In order to resolve this issue, a simple way is to set beamFailureInstanceMaxCount to be 1. But obviously, this hasty approach may lead to frequent BFR (e.g., transient obtascle), which is unexpected.

In view of this, embodiments of the present disclosure provide solutions of managing BFD. These solutions will be described below in connection with Embodiments 18 to 19.

### Embodiment 18

In this embodiment, if a BFD-RS is changed in application time associated with the set of TCI states, the terminal device 110 may determine that the BFR procedure is to be performed. The terminal device 110 may perform the BFR procedure by disabling a setting of a value of a counter (BFI_COUNTER) configured for BFI to zero. In other words, if a BFD-RS is changed in application time associated with the set of TCI states, the terminal device 110 may increase the value of BFI_COUNTER.

FIG. 6B illustrates a schematic diagram 600B illustrating an example management of a BFD procedure according to some embodiments of the present disclosure. For convenience, the network device 120 is shown as gNB and the terminal device 110 is shown as UE. As shown in FIG. 6B, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

During the application time of these TCI states, even if the BFD-RS (or the beam of the CORESET) is switched or changed, the current ongoing BFD or BFR procedure is not initialized or stopped. For example, as shown in FIG. 6B, at timing TA in application time associated with TCI-5, BFI_COUNTER is set to be 1. When the TCI state is switched from TCI-5 to TCI-11 at timing T2, BFI_COUNTER is not set to 0. In other words, the restriction (set BFI_COUNTER to 0 if the BFD-RS is switched) can be relieved. In this example, beamFailureInstanceMaxCount is set to 2. At timing TB in application time associated with TCI-11, BFI_COUNTER is increased to 2. Thus, a beam failure is declared. It is to be understood that FIG. 6B is merely an example, and is not intended for limitation.

### Embodiment 19

In this embodiment, BFI_COUNTER is set to zero if any of BFD-RSs is switched, and one or more new parameters for a BFD procedure are introduced. For example, the parameters may comprise a further counter TCI_COUNTER and a threshold value TCIMaxCount.

In some embodiments, if a value of the counter BFI_COUNTER in application time associated with a TCI sate in the set of TCI states is greater than or equal to a first threshold value (i.e., beamFailureInstanceMaxCount), the terminal device 110 may increase a value of the counter TCI_COUNTER by one. If the value of the counter TCI_COUNTER is greater than a second threshold value (i.e., TCIMaxCount), the terminal device 110 may determine that a beam failure is detected. In some embodiments, if a value of the counter BFI_COUNTER in application time associated with a TCI sate in the set of TCI states is smaller than the first threshold value, the terminal device 110 may set a value of the counter BFI_COUNTER to zero.

In other words, the counter TCI_COUNTER refers to the number of TCI states in the TCI set that satisfy the following conditions: during the application time of the TCI state, the BFI event has been declared M (M>=0) times. In other words, if it has been declare once (M=1), BFI_COUNTER=1; if it has been declared twice (M=2), BFI_COUNTER=2. Furthermore, the counter TCI_COUNTER will be initialized to 0 at the starting point of applying the TCI set. Then, if during the application time of a TCI state in the TCI set, BFI_COUNTER>=M, increment TCI_COUNTER by 1; if during the application time of a TCI state in the TCI set, BFI_COUNTER<M, set TCI_COUNTER to 0. Further, the value of M depends on beamFailureInstanceMaxCount. E.g., M is lower than or equal to beamFailureInstanceMaxCount.

FIG. 6C illustrates a schematic diagram 600C illustrating an example management of a BFD procedure according to some embodiments of the present disclosure. For convenience, the network device 120 is shown as gNB and the terminal device 110 is shown as UE. As shown in FIG. 6C, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, assuming M=1. As shown in FIG. 6C, during the application time of TCI-2 (T0˜T1), BFI_COUNTER=0, so TCI_COUNETR-0. During the application time of TCI-5 (T1˜T2), BFI_COUNTER=1, so TCI_COUNTER=1. During the application time of TCI-11 (T2˜T3), BFI_COUNTER=1, so TCI_COUNTER-2. During the application time of TCI-26 (T3˜T4), BFI_COUNTER=0, so TCI_COUNTER=0.

The threshold value TCIMaxCount means that if TCI_COUNTER≥TCIMaxCount, a beam failure event will be declared, i.e., a BFR will be triggered. At the same time, the terminal device 110 may also assume that a beam set failure event is declared, that is, the TCI set is unavailable. In some embodiments, TCIMaxCount (≥1) may be configured by the network device 120 and determined according to a capability reported by the terminal device 110.

FIG. 6D illustrates a schematic diagram 600D illustrating an example management of a BFD procedure according to some embodiments of the present disclosure. For convenience, the network device 120 is shown as gNB and the terminal device 110 is shown as UE. As shown in FIG. 6C, at a timing T, the gNB may transmit, to the UE, a PDSCH carrying a MAC CE indicating the set of TCI states for CORESET-1. In this example, the CORESET-1 is indicated a TCI set including 4 TCI states and corresponding application time: TCI-2 and 2 ms, TCI-5 and 10 ms, TCI-11 and 4 ms, TCI-26 and 3 ms.

Upon reception of the PDSCH, the UE may transmit, to the gNB, a PUCCH carrying a HARQ-ACK corresponding to the PDSCH. Assuming that a delay for the MAC CE to take effect is 3 ms. At a timing T0 after 3 ms, the TCI-2 may be applied to the CORESET-1 from T0 to T1 (2 ms), the TCI-5 may be applied to the CORESET-1 from T1 to T2 (10 ms), the TCI-11 may be applied to the CORESET-1 from T2 to T3 (4 ms), and the TCI-26 may be applied to the CORESET-1 from T3 to T4 (3 ms).

For example, assuming TCIMaxCount=2. As shown in FIG. 6C, during the application time of TCI-2 (T0˜T1), BFI_COUNTER=0, so TCI_COUNETR-0. During the application time of TCI-5 (T1˜T2), BFI_COUNTER=1, so TCI_COUNTER=1. During the application time of TCI-11 (T2˜T3), BFI_COUNTER=1, so TCI_COUNTER=2. In this case, the value of TCI_COUNTER is equal to TCIMaxCount. Thus, a beam failure event will be declared at TB. It is to be understood that FIGS. 6C and 6D are merely for illustration, and not intended for limitation.

In this way, a beam failure may be detected in an effective way, and thus an effective BFR procedure can also be facilitated.

### Example Implementation of Methods

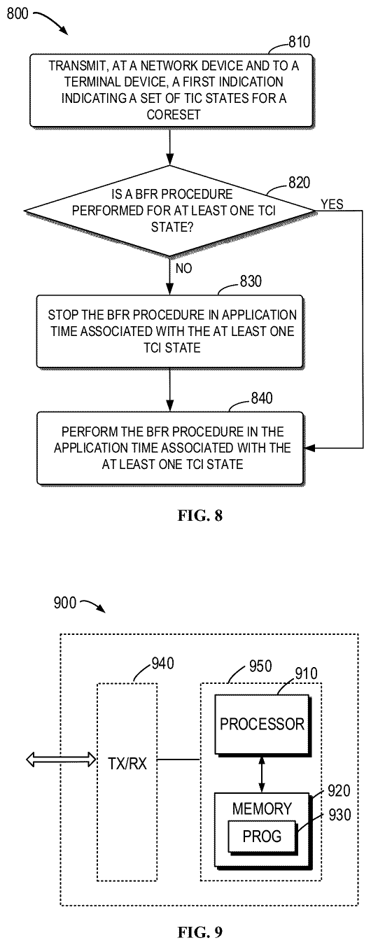

Accordingly, embodiments of the present disclosure provide methods of communication implemented at a terminal device and a network device. These methods will be described below with reference to FIGS. 7 to 8.

FIG. 7 illustrates an example method 700 of communication implemented at a terminal device in accordance with some embodiments of the present disclosure. For the purpose of discussion, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 receives, from the network device 120, a first indication indicating a set of TCI states for a CORESET.

At block 720, the terminal device 110 determines whether a BFR procedure is to be performed in application time associated with at least one TCI state in the set of TCI states.

If no BFR procedure is to be performed, the method 700 proceeds to block 730. At block 730, the terminal device 110 stops the BFR procedure in the application time associated with the at least one TCI state.

If the BFR procedure is to be performed, the method 700 proceeds to block 740. At block 740, the terminal device 110 performs the BFR procedure in the application time associated with the at least one TCI state.

In some embodiments, the terminal device 110 may receive, from the network device 120, a second indication indicating whether a beam prediction is enabled or disabled. If the beam prediction is enabled, the terminal device 110 may determine that no BFR procedure is to be performed. If the beam prediction is disabled, the terminal device 110 may determine that the BFR procedure is to be performed.

In some embodiments, the terminal device 110 may receive, from the network device 120, a third indication indicating a duration in which the beam prediction is to be applied; and determine that no BFR procedure is to be performed for the duration.

In some embodiments, the terminal device 110 may receive, from the network device 120, a fourth indication indicating a first duration in which a data collection stage for the beam prediction is to be performed and a second duration in which at least one of an inference or application stage for the beam prediction is to be performed; and determine that no BFR procedure is to be performed for at least one of the first duration or the second duration.

In some embodiments, the terminal device 110 may receive, from the network device 120, a fifth indication indicating whether the BFR procedure is enabled or disabled. If the BFR procedure is enabled, the terminal device 110 may determine that the BFR procedure is to be performed. If the BFR procedure is disabled, the terminal device 110 may determine that no BFR procedure is to be performed.

In some embodiments, the terminal device 110 may receive, from the network device 120, a sixth indication indicating a duration in which the BFR procedure is enabled; and determine that the BFR procedure is to be performed for the duration.

In some embodiments, the terminal device 110 may receive, from the network device 120, a seventh indication indicating a duration in which the BFR procedure is disabled; and determine that no BFR procedure is to be performed for the duration.

In some embodiments where no BFR procedure is to be performed, the terminal device 110 may stop the BFR procedure in application time associated with the set of TCI states.

In some embodiments, the terminal device 110 may determine whether the BFR procedure is to be performed based on a comparison between application time associated with a TCI state in the set of TCI states and threshold time. If the application time associated with the TCI state is shorter than or equal to the threshold time, the terminal device 110 may determine that no BFR procedure is to be performed in the application time associated with the TCI state. If the application time associated with the TCI state is longer than the threshold time, the terminal device 110 may determine that the BFR procedure is to be performed in the application time associated with the TCI state.

In some embodiments, the terminal device 110 may receive, from the network device 120, information indicating a first subset of TCI states and a second subset of TCI states. In these embodiments, the terminal device 110 may determine, based on the information and from the set of TCI states, the first subset of TCI states and the second subset of TCI states; and determine that the BFR procedure is to be performed in application time associated with the first subset of TCI states and that no BFR procedure is to be performed in application time associated with the second subset of TCI states.

In some embodiments, the terminal device 110 may determine whether the BFR procedure is to be performed based on a comparison between a value of a counter configured for BFI at a time offset before an expiration of a TCI state in the set of TCI states and a predetermined value. If the value of the counter is smaller than or equal to the predetermined value, the terminal device 110 may determine that no BFR procedure is to be performed in application time associated with the TCI state. If the value of the counter is greater than the predetermined value, the terminal device 110 may determine that the BFR procedure is to be performed in application time associated with the TCI state.

In some embodiments, the terminal device 110 may transmit, from a lower layer of the terminal device 110 to a higher layer of the terminal device 110, an eighth indication indicating the stopping of the BFR procedure; and set, by the higher layer of the terminal device, a counter configured for beam failure indication to zero.

In some embodiments, if a reference signal for beam failure detection is changed, the terminal device 110 may determine that the BFR procedure is to be performed. The terminal device 110 may perform the BFR procedure by setting a counter configured for beam failure indication to zero.

In some embodiments, the terminal device 110 may determine that the BFR procedure is to be performed in response to one of the following: no reference signal for beam failure detection being changed no later than a timing at which a beam is provided from a lower layer of the terminal device to a higher layer of the terminal device, the beam being determined from a predetermined set of beams in response to a detection of a beam failure in application time associated with a TCI state; a reference signal for beam failure detection being changed no later than the timing and the changed reference signal being different from the beam; or a time interval between the detection of the beam failure and a switching from the TCI state to another TCI state being larger than or equal to a threshold interval. In these embodiments, the terminal device 110 may perform the BFR procedure by indicating the beam from the lower layer of the terminal device to the higher layer of the terminal device.

In some embodiments, the terminal device 110 may determine that the BFR procedure is to be performed in response to one of the following: no reference signal for beam failure detection is changed no later than an uplink resource allocated for transmission of a BFR request; a reference signal for beam failure detection being changed no later than the uplink resource and the changed reference signal being different from a reference signal corresponding to a beam, the beam being determined from a predetermined set of beams in response to a detection of a beam failure in application time associated with a TCI state; or a time interval between the detection of the beam failure and a switching from the TCI state to another TCI state being larger than or equal to a threshold interval. In these embodiments, the terminal device 110 may perform the BFR procedure by transmitting, to the network device, the BFR request comprising information of the beam.

In some embodiments, the terminal device 110 may determine that the BFR procedure is to be performed in response to no reference signal for beam failure detection being changed no later than a period of time after a transmission of a BFR request in a first slot. In these embodiments, the terminal device 110 may perform the BFR procedure by monitoring, a response to the BFR request from the network device 120 at a second slot, the second slot being later than the first slot by the period of time.

In some embodiments, the terminal device 110 may determine that the BFR procedure is to be performed in response to no reference signal for beam failure detection being changed within a time window, the time window being configured for a monitoring of a response to a BFR request. In these embodiments, the terminal device 110 may perform the BFR procedure by monitoring the response to the BFR request within the time window.

In some embodiments, the terminal device 110 may determine that the BFR procedure is to be performed in response to no reference signal for beam failure detection being changed within a period of time corresponding to a predetermined number of symbols. In these embodiments, the terminal device 110 may perform the BFR procedure by applying a beam for signal transmission after the predetermined number of symbols from a reception of a response to a BFR request, the beam being indicated in the BFR request.

In some embodiments, the terminal device 110 may determine that the BFR procedure is to be performed until a TCI state is changed and a beam corresponding to the changed TCI state is different from a beam indicated in a BFR request. In these embodiments, the terminal device 110 may perform the BFR procedure by applying, after a predetermined number of symbols from a reception of a response to the BFR request, the beam indicated in the BFR request for signal transmission. In some embodiments, the terminal device 110 may apply the beam indicated in the BFR request until the terminal device switches to a predetermined TCI state in the set of TCI states after the applying of the beam indicated in the BFR request.

In some embodiments where the BFR procedure is to be performed, the terminal device 110 may perform the BFR procedure by dropping a subset of TCI states in the set of TCI states, the subset of TCI states being to be applied after a beam failure.

In some embodiments where the BFR procedure is to be performed, the terminal device 110 may perform the BFR procedure by dropping a subset of TCI states in the set of TCI states, the subset of TCI states being determined based on the first TCI state in the set of TCI states to be applied after a beam failure and a TCI state in the set of TCI states to be applied at or after applying of a beam indicated in a BFR request.

In some embodiments, if a reference signal for beam failure detection is changed in application time associated with the set of TCI states, the terminal device 110 may determine that the BFR procedure is to be performed. In these embodiments, the terminal device 110 may perform the BFR procedure by disabling a setting of a value of a counter configured for beam failure indication to zero.

In some embodiments, if a value of the counter in application time associated with a TCI sate in the set of TCI states is greater than or equal to a first threshold value, the terminal device 110 may increase a value of a further counter by one. If the value of the further counter is greater than a second threshold value, the terminal device 110 may determine that a beam failure is detected. In some embodiments, if the value of the counter in application time associated with the TCI sate in the set of TCI states is smaller than the first threshold value, the terminal device 110 may set the value of the further counter to zero.

With the method 700, a management of a BFR procedure based on beam prediction may be achieved. Other details are similar with that described in connection with FIGS. 2 to 6D and thus are not repeated here for concise.

FIG. 8 illustrates an example method 800 of communication implemented at a network device in accordance with some embodiments of the present disclosure. For example, the method 800 may be performed at the network device 120 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

As shown in FIG. 8, at block 810, the network device 120 transmits, to the terminal device 110, a first indication indicating a set of TCI states for a CORESET.

At block 820, the network device determines whether a BFR procedure is to be performed in application time associated with at least one TCI state in the set of TCI states.

If no BFR procedure is to be performed, the method 800 proceeds to block 830. At block 830, the network device 120 stops the BFR procedure in the application time associated with the at least one TCI state.

If the BFR procedure is to be performed, the method 800 proceeds to block 840. At block 840, the network device 120 performs the BFR procedure in the application time associated with the at least one TCI state.

In some embodiments, if no BFR procedure is to be performed, the network device 120 may transmit, to the terminal device 110, a second indication indicating a beam prediction is enabled. If the BFR procedure is to be performed, the network device 120 may transmit, to the terminal device 110, a second indication indicating a beam prediction is disabled.

In some embodiments, the network device 120 may transmit, to the terminal device 110, a third indication indicating a duration in which the beam prediction is to be applied.

In some embodiments, the network device 120 may transmit, to the terminal device 110, a fourth indication indicating a first duration in which a data collection stage for the beam prediction is to be performed and a second duration in which at least one of an inference or application stage for the beam prediction is to be performed; and determine that no BFR procedure is to be performed for at least one of the first duration or the second duration.

In some embodiments, if no BFR procedure is to be performed, the network device 120 may transmit, to the terminal device 110, a fifth indication indicating the BFR procedure is disabled. If the BFR procedure is to be performed, the network device 120 may transmit, to the terminal device 110, a fifth indication indicating the BFR procedure is enabled.

In some embodiments, the network device 120 may transmit, to the terminal device 110, a sixth indication indicating a duration in which the BFR procedure is enabled; and determine that the BFR procedure is to be performed for the duration.

In some embodiments, the network device 120 may transmit, to the terminal device 110, a seventh indication indicating a duration in which the BFR procedure is disabled; and determine that no BFR procedure is to be performed for the duration.

In some embodiments, the network device 120 may stop the BFR procedure in application time associated with the set of TCI states.

In some embodiments, the network device 120 may determine whether the BFR procedure is to be performed based on a comparison between application time associated with a TCI state in the set of TCI states and threshold time. If the application time associated with the TCI state is shorter than or equal to the threshold time, the network device 120 may determine that no BFR procedure is to be performed in the application time associated with the TCI state. If the application time associated with the TCI state is longer than the threshold time, the network device 120 may determine that the BFR procedure is to be performed in the application time associated with the TCI state.

In some embodiments, the network device 120 may determine, from the set of TCI states, a first subset of TCI states and a second subset of TCI states; determine that the BFR procedure is to be performed in application time associated with the first subset of TCI states and that no BFR procedure is to be performed in application time associated with the second subset of TCI states; and transmit, to the terminal device, information indicating the first subset of TCI states and the second subset of TCI states.

In some embodiments, the network device 120 may determine that the BFR procedure is to be performed in response to no reference signal for beam failure detection being changed no later than a period of time after a reception of a BFR request in a first slot. In these embodiments, the network device 120 may transmit a response to the BFR request to the terminal device at a second slot, the second slot being later than the first slot by the period of time.

In some embodiments, the network device 120 may determine that the BFR procedure is to be performed in response to no reference signal for beam failure detection being changed within a time window, the time window being configured for a transmission of a response to a BFR request. In these embodiments, the network device 120 may transmit the response to the BFR request within the time window.

In some embodiments, the network device 120 may determine that the BFR procedure is to be performed in response to no reference signal for beam failure detection being changed within a period of time corresponding to a predetermined number of symbols. In these embodiments, the network device 120 may apply a beam for signal transmission after the predetermined number of symbols from a transmission of a response to a BFR request, the beam being indicated in the BFR request.

In some embodiments, the network device 120 may determine that the BFR procedure is to be performed until a TCI state is changed and a beam corresponding to the changed TCI state is different from a beam indicated in a BFR request from the terminal device. In these embodiments, the network device 120 may apply, after a predetermined number of symbols from a transmission of a response to the BFR request, the beam indicated in the BFR request for signal transmission. In some embodiments, the network device 120 may apply the beam indicated in the BFR request until the network device switches to a predetermined TCI state in the set of TCI states after the applying of the beam indicated in the BFR request.

In some embodiments, the network device 120 may drop a subset of TCI states in the set of TCI states, the subset of TCI states being to be applied after a beam failure.

In some embodiments, the network device 120 may drop a subset of TCI states in the set of TCI states, the subset of TCI states being determined based on the first TCI state in the set of TCI states to be applied after a beam failure and a TCI state in the set of TCI states to be applied at or after applying of a beam indicated in a BFR request.

With the method 800, a management of a BFR procedure based on beam prediction may be achieved. Other details are similar with that described in connection with FIGS. 2 to 6D and thus are not repeated here for concise.

### Example Implementation of Devices and Apparatuses

FIG. 9 is a simplified block diagram of a device 900 that is suitable for implementing embodiments of the present disclosure. The device 900 can be considered as a further example implementation of the terminal device 110 or the network device 120 as shown in FIG. 1. Accordingly, the device 900 can be implemented at or as at least a part of the terminal device 110 or the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprise a circuitry configured to: receive, from a network device, a first indication indicating a set of TCI states for a CORESET; determine whether a beam failure recovery, BFR, procedure is to be performed in application time associated with at least one TCI state in the set of TCI states; in accordance with a determination that no BFR procedure is to be performed, stop the BFR procedure in the application time associated with the at least one TCI state; and in accordance with a determination that the BFR procedure is to be performed, perform the BFR procedure in the application time associated with the at least one TCI state.

In some embodiments, the circuitry may be configured to determine whether the BFR procedure is to be performed by: receiving, from the network device, a second indication indicating whether a beam prediction is enabled or disabled; in accordance with a determination that the beam prediction is enabled, determining that no BFR procedure is to be performed; and in accordance with a determination that the beam prediction is disabled, determining that the BFR procedure is to be performed.

In some embodiments, the circuitry may be configured to determine whether the BFR procedure is to be performed by: receiving, from the network device, a third indication indicating a duration in which the beam prediction is to be applied; and determining that no BFR procedure is to be performed for the duration.

In some embodiments, the circuitry may be configured to determine whether the BFR procedure is to be performed by: receiving, from the network device, a fourth indication indicating a first duration in which a data collection stage for the beam prediction is to be performed and a second duration in which at least one of an inference or application stage for the beam prediction is to be performed; and determining that no BFR procedure is to be performed for at least one of the first duration or the second duration.

In some embodiments, the circuitry may be configured to determine whether the BFR procedure is to be performed by: receiving, from the network device, a fifth indication indicating whether the BFR procedure is enabled or disabled; in accordance with a determination that the BFR procedure is enabled, determining that the BFR procedure is to be performed; and in accordance with a determination that the BFR procedure is disabled, determining that no BFR procedure is to be performed.

In some embodiments, the circuitry may be configured to determine whether the BFR procedure is to be performed by: receiving, from the network device, a sixth indication indicating a duration in which the BFR procedure is enabled; and determining that the BFR procedure is to be performed for the duration.

In some embodiments, the circuitry may be configured to determine whether the BFR procedure is to be performed by: receiving, from the network device, a seventh indication indicating a duration in which the BFR procedure is disabled; and determining that no BFR procedure is to be performed for the duration.

In some embodiments, the circuitry may be configured to stop the BFR procedure by: stopping the BFR procedure in application time associated with the set of TCI states.

In some embodiments, the circuitry may be configured to determine whether the BFR procedure is to be performed by: in accordance with a determination that application time associated with a TCI state in the set of TCI states is shorter than the threshold time, determining that no BFR procedure is to be performed in the application time associated with the TCI state; and in accordance with a determination that the application time associated with the TCI state is longer than the threshold time, determining that the BFR procedure is to be performed in the application time associated with the TCI state.

In some embodiments, the circuitry may be configured to determine whether the BFR procedure is to be performed by: receiving, from the network device, information indicating a first subset of TCI states and a second subset of TCI states; determining, based on the information and from the set of TCI states, the first subset of TCI states and the second subset of TCI states; and determining that the BFR procedure is to be performed in application time associated with the first subset of TCI states and that no BFR procedure is to be performed in application time associated with the second subset of TCI states.

In some embodiments, the circuitry may be configured to determine whether the BFR procedure is to be performed by: in accordance with a determination that a value of a counter configured for BFI is smaller than or equal to a predetermined value at a time offset before an expiration of a TCI state in the set of TCI states, determining that no BFR procedure is to be performed in application time associated with the TCI state; and in accordance with a determination that the value of the counter is greater than the predetermined value, determining that the BFR procedure is to be performed in application time associated with the TCI state.

In some embodiments, the circuitry may be further configured to: transmit, from a lower layer of the terminal device to a higher layer of the terminal device, an eighth indication indicating the stopping of the BFR procedure; and set, by the higher layer of the terminal device, a counter configured for beam failure indication to zero.

In some embodiments, the circuitry may be configured to determine whether the BFR procedure is to be performed by: in accordance with a determination that a reference signal for beam failure detection is changed, determining that the BFR procedure is to be performed. In these embodiments, the circuitry may be configured to perform the BFR procedure by: setting a counter configured for beam failure indication to zero.

In some embodiments, the circuitry may be configured to determine whether the BFR procedure is to be performed by determining that the BFR procedure is to be performed in response to one of the following: no reference signal for beam failure detection being changed no later than a timing at which a beam is provided from a lower layer of the terminal device to a higher layer of the terminal device, the beam being determined from a predetermined set of beams in response to a detection of a beam failure in application time associated with a TCI state; a reference signal for beam failure detection being changed no later than the timing and the changed reference signal being different from the beam; or a time interval between the detection of the beam failure and a switching from the TCI state to another TCI state being larger than or equal to a threshold interval. In these embodiments, the circuitry may be configured to perform the BFR procedure by: indicating the beam from the lower layer of the terminal device to the higher layer of the terminal device.

In some embodiments, the circuitry may be configured to determine whether the BFR procedure is to be performed by determining that the BFR procedure is to be performed in response to one of the following: no reference signal for beam failure detection is changed no later than an uplink resource allocated for transmission of a BFR request; a reference signal for beam failure detection being changed no later than the uplink resource and the changed reference signal being different from a reference signal corresponding to a beam, the beam being determined from a predetermined set of beams in response to a detection of a beam failure in application time associated with a TCI state; or a time interval between the detection of the beam failure and a switching from the TCI state to another TCI state being larger than or equal to a threshold interval. In these embodiments, the circuitry may be configured to perform the BFR procedure by: transmitting, to the network device, the BFR request comprising information of the beam.

In some embodiments, the circuitry may be configured to determine whether the BFR procedure is to be performed by: determining that the BFR procedure is to be performed in response to no reference signal for beam failure detection being changed no later than a period of time after a transmission of a BFR request in a first slot. In these embodiments, the circuitry may be configured to perform the BFR procedure by: monitoring, a response to the BFR request from the network device at a second slot, the second slot being later than the first slot by the period of time.

In some embodiments, the circuitry may be configured to determine whether the BFR procedure is to be performed by: determining that the BFR procedure is to be performed in response to no reference signal for beam failure detection being changed within a time window, the time window being configured for a monitoring of a response to a BFR request. In these embodiments, the circuitry may be configured to perform the BFR procedure by: monitoring the response to the BFR request within the time window.

In some embodiments, the circuitry may be configured to determine whether the BFR procedure is to be performed by: determining that the BFR procedure is to be performed in response to no reference signal for beam failure detection being changed within a period of time corresponding to a predetermined number of symbols. In these embodiments, the circuitry may be configured to perform the BFR procedure by: applying a beam for signal transmission after the predetermined number of symbols from a reception of a response to a BFR request, the beam being indicated in the BFR request.

In some embodiments, the circuitry may be configured to determine whether the BFR procedure is to be performed by: determining that the BFR procedure is to be performed until a TCI state is changed and a beam corresponding to the changed TCI state is different from a beam indicated in a BFR request. In these embodiments, the circuitry may be configured to perform the BFR procedure by: applying, after a predetermined number of symbols from a reception of a response to the BFR request, the beam indicated in the BFR request for signal transmission. In some embodiments, the circuitry may be configured to apply the beam indicated in the BFR request by: applying the beam indicated in the BFR request until the terminal device switches to a predetermined TCI state in the set of TCI states after the applying of the beam indicated in the BFR request.

In some embodiments, the circuitry may be configured to perform the BFR procedure by: dropping a subset of TCI states in the set of TCI states, the subset of TCI states being to be applied after a beam failure.

In some embodiments, the circuitry may be configured to perform the BFR procedure by: dropping a subset of TCI states in the set of TCI states, the subset of TCI states being determined based on the first TCI state in the set of TCI states to be applied after a beam failure and a TCI state in the set of TCI states to be applied at or after applying of a beam indicated in a BFR request.

In some embodiments, the circuitry may be configured to determine whether the BFR procedure is to be performed by: in accordance with a determination that a reference signal for beam failure detection is changed in application time associated with the set of TCI states, determining that the BFR procedure is to be performed. In some embodiments, the circuitry may be configured to perform the BFR procedure by: disabling a setting of a value of a counter configured for beam failure indication to zero.

In some embodiments, the circuitry may be configured to perform the BFR procedure by: in accordance with a determination that a value of the counter in application time associated with a TCI sate in the set of TCI states is greater than or equal to a first threshold value, increasing a value of a further counter by one; and in accordance with a determination that the value of the further counter is greater than a second threshold value, determining that a beam failure is detected.

In some embodiments, the circuitry may be further configured to: in accordance with a determination that the value of the counter in application time associated with the TCI sate in the set of TCI states is smaller than the first threshold value, setting the value of the further counter to zero.

In some embodiments, a network device comprises a circuitry configured to: transmit, to a terminal device, a first indication indicating a set of TCI states for a CORESET; determine whether a BFR procedure is to be performed in application time associated with at least one TCI state in the set of TCI states; in accordance with a determination that no BFR procedure is to be performed, stopping the BFR procedure in the application time associated with the at least one TCI state; and in accordance with a determination that the BFR procedure is to be performed, performing the BFR procedure in the application time associated with the at least one TCI state.

In some embodiments, the circuitry may be further configured to: in accordance with a determination that no BFR procedure is to be performed, transmit, to the terminal device, a second indication indicating a beam prediction is enabled; or in accordance with a determination that the BFR procedure is to be performed, transmit, to the terminal device, a second indication indicating a beam prediction is disabled.

In some embodiments, the circuitry may be further configured to: transmit, to the terminal device, a third indication indicating a duration in which the beam prediction is to be applied.

In some embodiments, the circuitry may be further configured to: transmit, to the terminal device, a fourth indication indicating a first duration in which a data collection stage for the beam prediction is to be performed and a second duration in which at least one of an inference or application stage for the beam prediction is to be performed; and determine that no BFR procedure is to be performed for at least one of the first duration or the second duration.

In some embodiments, the circuitry may be further configured to: in accordance with a determination that no BFR procedure is to be performed, transmit, to the terminal device, a fifth indication indicating the BFR procedure is disabled; and in accordance with a determination that the BFR procedure is to be performed, transmit, to the terminal device, a fifth indication indicating the BFR procedure is enabled.

In some embodiments, the circuitry may be further configured to: transmit, to the terminal device, a sixth indication indicating a duration in which the BFR procedure is enabled; and determine that the BFR procedure is to be performed for the duration.

In some embodiments, the circuitry may be further configured to: transmit, to the terminal device, a seventh indication indicating a duration in which the BFR procedure is disabled; and determine that no BFR procedure is to be performed for the duration.

In some embodiments, the circuitry may be configured to stop the BFR procedure by: stopping the BFR procedure in application time associated with the set of TCI states.

In some embodiments, the circuitry may be further configured to: in accordance with a determination that application time associated with a TCI state in the set of TCI states is shorter than the threshold time, determine that no BFR procedure is to be performed in the application time associated with the TCI state; and in accordance with a determination that the application time associated with the TCI state is longer than the threshold time, determine that the BFR procedure is to be performed in the application time associated with the TCI state.

In some embodiments, the circuitry may be further configured to: determine, from the set of TCI states, a first subset of TCI states and a second subset of TCI states; determine that the BFR procedure is to be performed in application time associated with the first subset of TCI states and that no BFR procedure is to be performed in application time associated with the second subset of TCI states; and transmit, to the terminal device, information indicating the first subset of TCI states and the second subset of TCI states.

In some embodiments, the circuitry may be configured to determine whether the BFR procedure is to be performed by: determining that the BFR procedure is to be performed in response to no reference signal for beam failure detection being changed no later than a period of time after a reception of a BFR request in a first slot. In these embodiments, the circuitry may be configured to perform the BFR procedure by: transmitting a response to the BFR request to the terminal device at a second slot, the second slot being later than the first slot by the period of time.

In some embodiments, the circuitry may be configured to determine whether the BFR procedure is to be performed by: determining that the BFR procedure is to be performed in response to no reference signal for beam failure detection being changed within a time window, the time window being configured for a transmission of a response to a BFR request. In these embodiments, the circuitry may be configured to perform the BFR procedure by: transmitting the response to the BFR request within the time window.

In these embodiments, the circuitry may be configured to determine whether the BFR procedure is to be performed by: determining that the BFR procedure is to be performed in response to no reference signal for beam failure detection being changed within a period of time corresponding to a predetermined number of symbols. In these embodiments, the circuitry may be configured to perform the BFR procedure by: applying a beam for signal transmission after the predetermined number of symbols from a transmission of a response to a BFR request, the beam being indicated in the BFR request.

In some embodiments, the circuitry may be configured to determine whether the BFR procedure is to be performed by: determining that the BFR procedure is to be performed until a TCI state is changed and a beam corresponding to the changed TCI state is different from a beam indicated in a BFR request from the terminal device. In these embodiments, the circuitry may be configured to perform the BFR procedure by: applying, after a predetermined number of symbols from a transmission of a response to the BFR request, the beam indicated in the BFR request for signal transmission. In some embodiments, the circuitry may be configured to apply the beam indicated in the BFR request by: applying the beam indicated in the BFR request until the network device switches to a predetermined TCI state in the set of TCI states after the applying of the beam indicated in the BFR request.

In these embodiments, the circuitry may be configured to perform the BFR procedure by: dropping a subset of TCI states in the set of TCI states, the subset of TCI states being to be applied after a beam failure.

In these embodiments, the circuitry may be configured to perform the BFR procedure by: dropping a subset of TCI states in the set of TCI states, the subset of TCI states being determined based on the first TCI state in the set of TCI states to be applied after a beam failure and a TCI state in the set of TCI states to be applied at or after applying of a beam indicated in a BFR request.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-44. (canceled)

45. A method of communication, comprising:
receiving, at a terminal device and from a network device, a first indication indicating a set of transmission configuration indicator, TCI, states for a control resource set, CORESET;
determining whether a beam failure recovery, BFR, procedure is to be performed in application time associated with at least one TCI state in the set of TCI states;
in accordance with a determination that no BFR procedure is to be performed, stopping the BFR procedure in the application time associated with the at least one TCI state; and
in accordance with a determination that the BFR procedure is to be performed, performing the BFR procedure in the application time associated with the at least one TCI state.

46. The method of claim 45, wherein determining whether the BFR procedure is to be performed comprises:
receiving, from the network device, a second indication indicating whether a beam prediction is enabled or disabled;
in accordance with a determination that the beam prediction is enabled, determining that no BFR procedure is to be performed; and
in accordance with a determination that the beam prediction is disabled, determining that the BFR procedure is to be performed.

47. The method of claim 45, wherein determining whether the BFR procedure is to be performed comprises:
receiving, from the network device, a fourth indication indicating a first duration in which a data collection stage for the beam prediction is to be performed and a second duration in which at least one of an inference or application stage for the beam prediction is to be performed; and
determining that no BFR procedure is to be performed for at least one of the first duration or the second duration.

48. The method of claim 45, wherein determining whether the BFR procedure is to be performed comprises:
receiving, from the network device, a fifth indication indicating whether the BFR procedure is enabled or disabled;
in accordance with a determination that the BFR procedure is enabled, determining that the BFR procedure is to be performed; and
in accordance with a determination that the BFR procedure is disabled, determining that no BFR procedure is to be performed.

49. The method of claim 45, wherein stopping the BFR procedure comprises:
stopping the BFR procedure in application time associated with the set of TCI states.

50. The method of claim 45, wherein determining whether the BFR procedure is to be performed comprises:
in accordance with a determination that application time associated with a TCI state in the set of TCI sates is shorter than or equal to threshold time, determining that no BFR procedure is to be performed in the application time associated with the TCI state; and
in accordance with a determination that the application time associated with the TCI state is longer than the threshold time, determining that the BFR procedure is to be performed in the application time associated with the TCI state.

51. The method of claim 45, wherein determining whether the BFR procedure is to be performed comprises:
receiving, from the network device, information indicating a first subset of TCI states and a second subset of TCI states;
determining, based on the information and from the set of TCI states, the first subset of TCI states and the second subset of TCI states; and
determining that the BFR procedure is to be performed in application time associated with the first subset of TCI states and that no BFR procedure is to be performed in application time associated with the second subset of TCI states.

52. The method of claim 45, wherein determining whether the BFR procedure is to be performed comprises:
in accordance with a determination that a value of a counter configured for beam failure indication is smaller than or equal to a predetermined value at a time offset before an expiration of a TCI state in the set of TCI states, determining that no BFR procedure is to be performed in application time associated with the TCI state; and
in accordance with a determination that the value of the counter is greater than the predetermined value, determining that the BFR procedure is to be performed in application time associated with the TCI state.

53. The method of claim 45, wherein determining whether the BFR procedure is to be performed comprises determining that the BFR procedure is to be performed in response to at least one of the following:
no reference signal for beam failure detection being changed no later than a timing at which a beam is provided from a lower layer of the terminal device to a higher layer of the terminal device, the beam being determined from a predetermined set of beams in response to a detection of a beam failure in application time associated with a TCI state;
a reference signal for beam failure detection being changed no later than the timing and the changed reference signal being different from the beam; or
a time interval between the detection of the beam failure and a switching from the TCI state to another TCI state being larger than or equal to a threshold interval, and
wherein performing the BFR procedure comprises:
indicating the beam from the lower layer of the terminal device to the higher layer of the terminal device.

54. The method of claim 45, wherein determining whether the BFR procedure is to be performed comprises determining that the BFR procedure is to be performed in response to at least one of the following:
no reference signal for beam failure detection is changed no later than an uplink resource allocated for transmission of a BFR request;
a reference signal for beam failure detection being changed no later than the uplink resource and the changed reference signal being different from a reference signal corresponding to a beam, the beam being determined from a predetermined set of beams in response to a detection of a beam failure in application time associated with a TCI state; or
a time interval between the detection of the beam failure and a switching from the TCI state to another TCI state being larger than or equal to a threshold interval, and
wherein performing the BFR procedure comprises:
transmitting, to the network device, the BFR request comprising information of the beam.

55. The method of claim 45, wherein determining whether the BFR procedure is to be performed comprises:
determining that the BFR procedure is to be performed in response to no reference signal for beam failure detection being changed no later than a period of time after a transmission of a BFR request in a first slot, and
wherein performing the BFR procedure comprises:
monitoring, a response to the BFR request from the network device at a second slot, the second slot being later than the first slot by the period of time.

56. The method of claim 45, wherein determining whether the BFR procedure is to be performed comprises:
determining that the BFR procedure is to be performed in response to no reference signal for beam failure detection being changed within a time window, the time window being configured for a monitoring of a response to a BFR request, and
wherein performing the BFR procedure comprises:
monitoring the response to the BFR request within the time window.

57. The method of claim 45, wherein determining whether the BFR procedure is to be performed comprises:
determining that the BFR procedure is to be performed in response to no reference signal for beam failure detection being changed within a period of time corresponding to a predetermined number of symbols, and
wherein performing the BFR procedure comprises:
applying a beam for signal transmission after the predetermined number of symbols from a reception of a response to a BFR request, the beam being indicated in the BFR request.

58. The method of claim 45, wherein determining whether the BFR procedure is to be performed comprises:
determining that the BFR procedure is to be performed until a TCI state is changed and a beam corresponding to the changed TCI state is different from a beam indicated in a BFR request,
wherein performing the BFR procedure comprises:
applying, after a predetermined number of symbols from a reception of a response to the BFR request, the beam indicated in the BFR request for signal transmission.

59. The method of claim 58, wherein applying the beam indicated in the BFR request comprises:
applying the beam indicated in the BFR request until the terminal device switches to a predetermined TCI state in the set of TCI states after the applying of the beam indicated in the BFR request.

60. The method of claim 45, wherein performing the BFR procedure comprises:
dropping a subset of TCI states in the set of TCI states, the subset of TCI states being to be applied after a beam failure.

61. The method of claim 45, wherein performing the BFR procedure comprises:
dropping a subset of TCI states in the set of TCI states, the subset of TCI states being determined based on the first TCI state in the set of TCI states to be applied after a beam failure and a TCI state in the set of TCI states to be applied at or after applying of a beam indicated in a BFR request.

62. The method of claim 45, wherein determining whether the BFR procedure is to be performed comprises:
in accordance with a determination that a reference signal for beam failure detection is changed in application time associated with the set of TCI states, determining that the BFR procedure is to be performed; and
wherein performing the BFR procedure comprises:
disabling a setting of a value of a counter configured for beam failure indication to zero.

63. A method of communication, comprising:
transmitting, at a network device and to a terminal device, a first indication indicating a set of transmission configuration indicator, TCI, states for a control resource set, CORESET;
determining whether a beam failure recovery, BFR, procedure is to be performed in application time associated with at least one TCI state in the set of TCI states;
in accordance with a determination that no BFR procedure is to be performed, stopping the BFR procedure in the application time associated with the at least one TCI state; and
in accordance with a determination that the BFR procedure is to be performed, performing the BFR procedure in the application time associated with the at least one TCI state.

64. A terminal device comprising:
a processor configured to cause the terminal device to perform the method according to claim 45.
